(19) United States
(12) Patent Application Publication
(10) Pub. No.: US 2024/0032713 A1
(43) Pub. Date: Feb. 1, 2024

(54) SYSTEMS AND METHODS FOR INTERCONNECTING AND HANGING PIECES OF MATERIAL

(71) Applicant: Pelemento, LLC, Newberg, OR (US)

(72) Inventor: John Macy, Newberg, OR (US)

(21) Appl. No.: 17/874,084

(22) Filed: Jul. 26, 2022

(51) Int. Cl. A47G 1/06

(52) U.S. Cl. CPC A47G 1/065; A47G 2001/0672

(57) ABSTRACT

Systems and methods for interconnecting and hanging pieces of material are disclosed. The systems may include a kit including pieces of material, clips, and hanging elements. A clip may have a base with a planar front surface, and extending therefrom, a post and a retaining projection. A piece of material is configured to be coupled to the clip using the post and the retaining projection. A hanging element may have a base with a planar front surface, a planar back surface, and a straight rail extending from the planar front surface at a periphery of the base. A clip having a straight groove is configured to slidingly engage with the straight rail of the hanging element, and the planar back surface of the hanging element can be mounted to a structure. The kit is usable to interconnect and hang pieces of material to a structure to create a decoration.

### BACKGROUND

Wall decorations come in a variety of forms. Familiar wall decorations include picture frames and canvas prints, which can be hung on the wall using a hanging tool (e.g., a hanging wire, a sawtooth hanger, etc.) on the back of the wall decoration. Other types of wall decorations include systems for creating and hanging photo collages, but these systems are typically single-use in that parts of the wall decoration (e.g., the photos) are destroyed when a user disassembles the wall decoration. Some existing systems are also difficult to assemble, hang, and/or level on the wall, leading to user frustration.

The disclosure made herein is presented with respect to these and other considerations.

### SUMMARY

Disclosed herein are, among other things, systems and methods for interconnecting and hanging pieces of material. For example, the systems described herein may include a kit with pieces of material, such as card stock, as well as various component parts for interconnecting and hanging the pieces of material to create a decoration. For instance, each piece of material in the kit may have a portion of a photograph or work of art printed thereon such that when all of the pieces of material are properly arranged, interconnected, and hung on a structure (e.g., a wall), an art decoration is thereby created. Moreover, as will be described in more detail below, the systems and methods described herein provide a nondestructive, affordable, eco-friendly solution for creating a decoration (e.g., art, décor, etc.) that is easy-to-assemble and disassemble, alterable, removably mountable, and customizable to user preferences.

An example kit for interconnecting and hanging pieces of material may include, among other things, multiple pieces of material, multiple clips, and multiple hanging elements. Each hanging element is configured to be mounted to a structure (e.g., a wall) with an adhesive, which allows for hanging the pieces of material on the structure. Individual hanging elements are configured to slidingly engage with a clip in the kit, which allows pieces of material to be hung on a structure. Furthermore, each clip is configured to be coupled to a piece of material. Certain clips in the kit may have a straight groove defined therein, which is configured to slidingly engage with a straight rail of a hanging element. Other clips in the kit are configured to interconnect pieces of material together, without necessarily being coupled to a hanging element. Each piece of material may have at least one hole, or perforations to make the hole(s), at a periphery of the material. In this way the hole(s) can be used to couple the piece of material to one or more of the clips. The result of interconnecting and hanging the pieces of material using the components of the kit is a decoration made of the interconnected pieces of material.

The clips can be coupled to the pieces of material in a nondestructive manner, meaning that the pieces of material can be coupled to, and removed from, the clips repeatedly without destroying the pieces of material. For example, an individual clip may have a base with a planar front surface and a post extending from the planar front surface. The post can be inserted through a corresponding hole in the piece of material in order to couple the piece of material to the clip. The base of the clip also has a retaining projection that extends from the planar front surface. The post and the retaining projection are spaced a distance apart from each other to allow for a portion of the piece of material to be disposed between the post and the retaining projection. Furthermore, a distal end of the retaining projection is wider than a proximal end of the retaining projection to create a notch(es) between the retaining projection and the planar front surface of the base. Accordingly, when a piece of material is placed over the post, a portion of the piece of material can be positioned in a notch created by the retaining projection so that the retaining projection inhibits the piece of material from sliding off of the post as long as the piece of material remains flat against the clip. However, a user can easily remove the piece of material from the clip without destroying the material by orienting the piece of material at an angle while pulling the material over the post, out of the notch, and away from the clip. This clip design allows a user to easily disassemble and re-assemble the decoration, and/or alter the decoration by rearranging the pieces of material, and/or move the decoration to another location. A user may do this repeatedly without destroying the pieces of material.

The sliding engagement between the hanging elements and certain clips also allows for coupling the pieces of material (which may be flexible) to those clips without destroying the pieces of material. For example, a user can mount a hanging element to a structure (e.g., a wall), slide a clip onto the straight rail of the hanging element, move the clip in either direction along the straight rail of the hanging element in order to couple a piece of material to the clip, and then slide the clip into a resting position on the straight rail, whereafter the piece of material lays flat against the clip (e.g., parallel to the structure to which the hanging element is mounted), and the piece of material is not destroyed in this process due to the “play” of the clip created by the sliding engagement between the clip and the hanging element.

While the examples described herein pertain primarily to pieces of material such as card stock used for printing photographs or other works of art thereon, it is to be appreciated that the disclosed systems and methods can be used to interconnect and hang pieces of any suitable type of material (e.g., sheet metal, plastic, cardboard, paper, etc.). Furthermore, although wall decorations are primarily discussed herein, it is to be appreciated that the disclosed systems and methods can be used to mount interconnected pieces of material to any suitable structure (e.g., a floor, a ceiling, etc.), and the resulting interconnected assembly can have any useful purpose, be it for decoration or another purpose.

Other features and advantages of the present disclosure will become apparent from the following description, which refers to the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an example kit for interconnecting and hanging pieces of material.

FIG. 2 illustrates an example decoration that can be created using the example kit of FIG. 1.

FIG. 3A illustrates a perspective view of an example inner clip that may be included in the example kit of FIG. 1.

FIG. 3B illustrates a front view of the example inner clip of FIG. 3A.

FIG. 3C illustrates a side view of the example inner clip of FIG. 3A.

FIG. 3D illustrates a perspective view of another example inner clip with fewer retaining projections than the example inner clip of FIGS. 3A-3C.

FIG. 4A illustrates a perspective view of an example edge clip that may be included in the example kit of FIG. 1.

FIG. 4B illustrates another perspective view of the example edge clip of FIG. 4A.

FIG. 4C illustrates a front view of the example edge clip of FIG. 4A.

FIG. 4D illustrates a back view of the example edge clip of FIG. 4A.

FIG. 4E illustrates a side view of the example edge clip of FIG. 4A.

FIG. 4F illustrates another side view of the example edge clip of FIG. 4A.

FIG. 4G illustrates another side view of the example edge clip of FIG. 4A.

FIG. 5A illustrates a perspective view of an example lower-right corner clip that may be included in the example kit of FIG. 1.

FIG. 5B illustrates another perspective view of the example lower-right corner clip of FIG. 5A.

FIG. 5C illustrates a front view of the example lower-right corner clip of FIG. 5A.

FIG. 5D illustrates a back view of the example lower-right corner clip of FIG. 5A.

FIG. 5E illustrates a side view of the example lower-right corner clip of FIG.

FIG. 5F illustrates a perspective view of an example upper-left corner clip that may be included in the example kit of FIG. 1.

FIG. 5G illustrates another perspective view of the example upper-left corner clip of FIG. 5F.

FIG. 5H illustrates a front view of the example upper-left corner clip of FIG. 5F.

FIG. 5I illustrates a back view of the example upper-left corner clip of FIG. 5F.

FIG. 5J illustrates a side view of the example upper-left corner clip of FIG. 5F.

FIG. 5K illustrates a perspective view of an example lower-left corner clip that may be included in the example kit of FIG. 1.

FIG. 5L illustrates another perspective view of the example lower-left corner clip of FIG. 5K.

FIG. 5M illustrates a front view of the example lower-left corner clip of FIG.

FIG. 5N illustrates a back view of the example lower-left corner clip of FIG. 5K.

FIG. 5O illustrates a side view of the example lower-left corner clip of FIG. 5K.

FIG. 5P illustrates a perspective view of an example upper-right corner clip that may be included in the example kit of FIG. 1.

FIG. 5Q illustrates another perspective view of the example upper-right corner clip of FIG. 5P.

FIG. 5R illustrates a front view of the example upper-right corner clip of FIG. 5P.

FIG. 5S illustrates a back view of the example upper-right corner clip of FIG. 5P.

FIG. 5T illustrates a side view of the example upper-right corner clip of FIG. 5P.

FIG. 6A illustrates a perspective view of an example top hanging element that may be included in the example kit of FIG. 1.

FIG. 6B illustrates a side view of the example top hanging element of FIG. 6A.

FIG. 6C illustrates a front view of the example top hanging element of FIG. 6A.

FIG. 7A illustrates a perspective view of an example bottom hanging element that may be included in the example kit of FIG. 1.

FIG. 7B illustrates a front view of the example bottom hanging element of FIG. 7A.

FIG. 7C illustrates a side view of the example bottom hanging element of FIG. 7A.

FIG. 7D illustrates a front view of another example bottom hanging element without a straight rail, but with an integrated post and retaining projection.

FIG. 7E illustrates a side view of the example bottom hanging element of FIG. 7D.

FIG. 7F illustrates a front view of another example bottom hanging element without a straight rail, but with an integrated post and retaining projection.

FIG. 7G illustrates a side view of the example bottom hanging element of FIG. 7F.

FIGS. 8A and 8B illustrate example steps of interconnecting and hanging pieces of material.

FIG. 9 illustrates a piece of material being coupled to an inner clip.

FIG. 10A illustrates a perspective view of an example locking clip that may be included in the example kit of FIG. 1.

FIG. 10B illustrates another perspective view of the example locking clip of FIG. 10A.

FIG. 10C illustrates a side view of the example locking clip of FIG. 10A.

FIG. 10D illustrates a back view of the example locking clip of FIG. 10A.

FIG. 11 illustrates an example decoration that can be created using the locking clip of FIGS. 10A-10D.

FIG. 12 illustrates other example corner and edge clips that may be included in a kit for interconnecting and hanging pieces of material.

FIG. 13 illustrates an example decoration that can be created using the example clips of FIG. 12.

### DETAILED DESCRIPTION

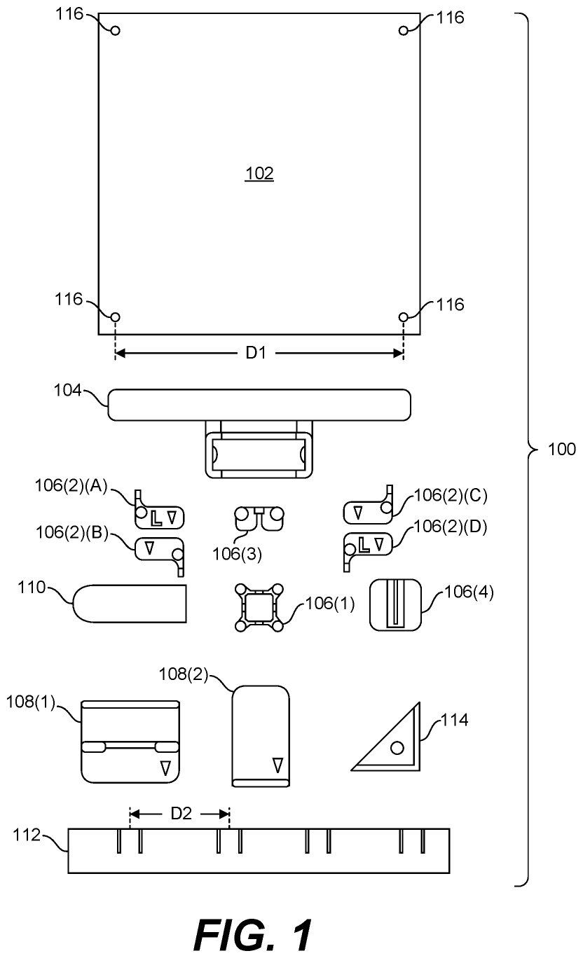

Referring to FIG. 1, there is illustrated a kit 100 for interconnecting and hanging pieces of material 102, according to an example embodiment. The example kit 100 depicted in FIG. 1 includes multiple pieces of the material 102, a leveling tool 104, multiple clips 106 including inner clips 106(1), corner clips 106(2)(A)-(D), edge clips 106(3), and/or locking clips 106(4), multiple hanging elements 108 including top hanging elements 108(1) and/or bottom hanging elements 108(2), command strips 110, a ruler 112, and/or a repair tool 114. It is to be appreciated that the kit 100 may exclude some of these components, in some examples, and/or the kit 100 may include additional components, in some examples. For instance, the kit 100 may include an instruction manual (not shown) that includes assembly instructions for interconnecting and hanging the pieces of material 102 and/or instructions for downloading a mobile application and/or navigating a browser to a uniform resource locator (URL) to retrieve such assembly instructions.

FIG. 1 depicts a single piece of material 102. It is to be appreciated, however, that the kit 100 may include any number of pieces of material 102, such as a few pieces of material 102, tens of pieces of material 102, hundreds of pieces of material 102, etc., which a user may interconnect and hang on a structure, such as a wall. Alternate terms such as “media,” “decoration,” “wall decoration,” “photographs,” “photos,” “sheets,” “tiles,” “cards,” or “art elements” may be used interchangeably herein to refer to the pieces of material 102 in FIG. 1. The pieces of material 102 may be made of any suitable material, combination of materials, or composite materials. For example, the pieces of material 102 may be made of card stock. In some examples, the card stock may have a portion of a photograph or another work of art (e.g., a drawing, painting, sketch, etc.) printed thereon. For example, a user may submit a photograph to a service provider who prints the photograph onto a large sheet of card stock, cuts the large sheet of card stock into multiple pieces of material 102, and then packages the pieces of material 102 in the kit 100. Such a kit 100 may then be shipped to the user who submitted the photograph, or to a different user as a gift. In other examples, the card stock included in the kit 100 may be blank, and the user may print, paint, draw, or sketch any suitable content on the card stock to create a work of art by interconnecting and hanging the pieces of material 102 on a structure. Although card stock is one example type of material that may be used for the pieces of material 102, the pieces of material 102 may be made of any other suitable type of material including, without limitation, sheet metal, plastic, cardboard, paper, wood, bamboo, or the like. In some examples, the pieces of material 102 are made of a relatively flexible, lightweight material that is relatively easy for a user to interconnect using the clips 106 described herein and/or to hang on a structure using the hanging elements 108 and/or the other components of the kit 100.

The individual pieces of material 102 may have any suitable shape. FIG. 1 depicts a square-shaped piece of material 102 that is planar and relatively thin (e.g., a square sheet of material). It is to be appreciated, however, that an individual piece of material 102 is not limited to a square-shaped piece of material 102, as the piece of material 102 may have any suitable shape including, without limitation, a circular shape, an oval shape, a triangular shape, a rectangular shape, a pentagonal shape, a hexagonal shape, an octagonal shape, or any suitable polygonal shape. Furthermore, although FIG. 1 depicts a flat, planar piece of material 102, it is to be appreciated that an individual piece of material 102 may be curved. In addition, although FIG. 1 depicts a piece of material 102 with sharp corners and straight edges, the piece of material 102 can have rounded corners, irregular edges, and/or other features cut into the material to create any suitable design aesthetic.

The individual pieces of material 102 may be of any suitable size. Taking the square-shaped piece of material 102 depicted in FIG. 1 as an example, the piece of material 102 may have width and length dimensions of 3×5 inches, 4×6 inches, 5×7 inches, 8×8 inches, 8×10 inches, 8.5×11 inches, 9×16 inches, 12×18 inches, 18×24 inches, or 24×36 inches. These are merely example sizes and it is to be appreciated that an individual piece of material 102 can be of a smaller, larger, and/or intermediate size to those listed herein. Furthermore, the pieces of material 102 included in the kit 100 may be of uniform size or variable size. For example, the kit 100 may include multiple pieces of material 102, each of the same size. Alternatively, the kit 100 may include one or more first pieces of material 102 of a first size, one or more second pieces of material 102 of a second size different (e.g., larger or smaller) than the first size, and so on. In this way, a variety of types of decorations can be created with uniform- or variable-sized pieces of material 102.

The individual pieces of material 102 may have one or more holes 116 defined therein. The hole(s) 116 defined in a piece of material 102 may be used for coupling the piece of material 102 to one or more of the clips 106. The example of FIG. 1 depicts a square-shaped piece of material 102 having four holes 116 defined therein, one hole 116 in each corner. In this example, each hole 116 can be used to couple the piece of material 102 to a respective clip 106, which means that four different clips 106 can be coupled to the individual piece of material 102 shown in FIG. 1, one clip 106 at each corner of the piece of material 102. In some examples, instead of a hole(s) 116, the piece of material 102 may include one or more perforations to make the hole(s) 116. For example, the piece of material 102 shown in FIG. 1 may have four circles of perforations, one in each corner that allows a circular section in each corner to be removed by a user to create the holes 116.

The leveling tool 104 may be used with the ruler 112 in order to mount the top hanging elements 108(1) to a structure, such as a wall, with an adhesive, as will be described in more detail below. The leveling tool 104 may be a bubble level, a laser level, or any other suitable type of leveling tool 104. The leveling tool 104 may include features that allow the leveling tool 104 to rest on, and slide along, a top edge of the ruler 112.

The clips 106 are configured to be coupled to the pieces of material 102. Alternate terms such as “connector,” “joining element,” “joint element,” or “connecting element” may be used interchangeably herein to refer to the clips 106 in FIG. 1. Some of the clips 106 are configured to be coupled to a hanging element 108 or to other clips 106. For example, the individual corner clips 106(2)(A)-(D) and/or the edge clips 106(3) may include a straight groove that is configured to slidingly engage with a straight rail on one or more of the hanging elements 108. This allows a user to slide the clips 106(2)(A)-(D), 106(3) back and forth along the straight rails of the hanging elements 108. As another example, the individual locking clips 106(4) may include a straight groove that is configured to slidingly engage with the retaining projections of certain clips 106, such as the inner clips 106(1), as will be described in more detail below. FIG. 1 depicts a single inner clip 106(1), a single edge clip 106(3), and a single locking clip 106(4). It is to be appreciated, however, that the kit 100 may include any number of inner clips 106(1), edge clips 106(3), and/or locking clips 106(4), such as a few clips 106, tens of clips 106, hundreds of clips 106, etc. Furthermore, although four corner clips 106(2)(A), 106(2)(B), 106(2)(C), and 106(2)(D) may be sufficient for hanging a rectangular-shaped decoration on a structure, such as a wall, the kit 100 may include fewer corner clips 106(2) or additional corner clips 106(2), such as extra clips 106 to ensure that a user has more than enough clips 106.

The hanging elements 108 are configured to slidingly engage with certain ones of the clips 106 (e.g., the corner clips 106(2)(A)-(D) and/or the edge clips 106(3)). The hanging elements 108 are also configured to be mounted to a structure, such as wall, with an adhesive. For example, a command strip 110 included in the kit 100 may be adhered to a planar back surface of a hanging element 108 so that the command strip 110 can be used to mount the hanging element 108 to a structure, such as a wall, by adhering the command strip 110 to the structure. FIG. 1 depicts a single top hanging element 108(1) and a single bottom hanging element 108(2). It is to be appreciated, however, that the kit 100 may include any number of hanging elements 108(1), such as a few hanging elements 108, tens of hanging elements 108, hundreds of hanging elements 108, etc.

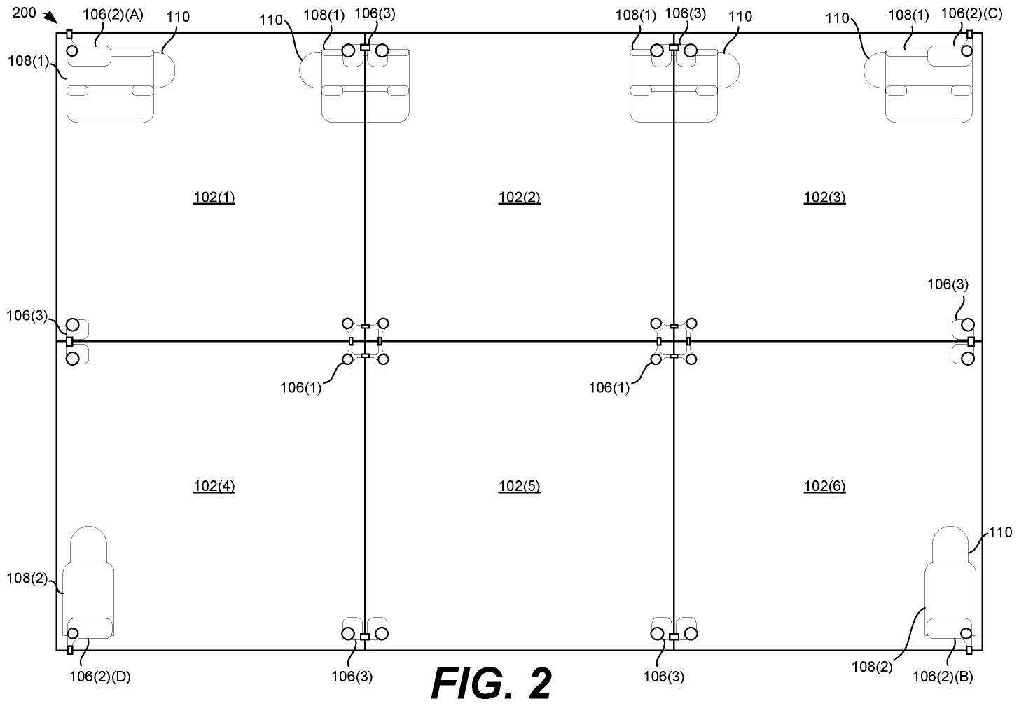

The clips 106 and/or the hanging elements 108 may be made of any suitable material, combination of materials, or composite materials. For example, the clips 106 and/or the hanging elements 108 can be made of a plastic (e.g., thermoplastic) material (e.g., acrylonitrile butadiene styrene (ABS) plastic) or a polymer material to produce components that are relatively rigid and also lightweight, which helps to minimize the overall weight of a decoration (e.g., the decoration 200 of FIG. 2). Alternatively, the clips 106 and/or the hanging elements 108 can be made of a metal, such as aluminum, stainless steel, titanium, copper, or any other suitable metallic material. In some examples, the clips 106 and/or the hanging elements 108 can be made of acrylic, Delrin, wood, a carbon fiber material, or any other material suitable for use in interconnecting pieces of material 102, such as card stock.

The clips 106 and/or the hanging elements 108 may be manufactured using a subtractive manufacturing process, such as a process where a block of material (e.g., plastic) is machined in order to create the shapes of the clips 106 and/or the hanging elements 108 as well as the various grooves, holes, features, and contours thereof, which are shown in the figures. Other suitable manufacturing techniques include, without limitation, injection molding, extrusion, three-dimensional (3D) printing (i.e., an additive manufacturing process), and the like.

The command strip 110 is an example of an adhesive that can be used to mount a hanging element 108 to a structure, such as a wall. In some examples, the command strip 110 includes protective liners on both sides that can be peeled away to expose adhesive sides of a double-sided command strip 110. In this example, one side of the command strip 110 can be adhered to a planar back surface of a hanging element 108, and the other side of the command strip 110 can be adhered to the structure (e.g., the wall). FIG. 1 depicts a single command strip 110. It is to be appreciated, however, that the kit 100 may include any number of command strips 110, such as a few command strips 110, tens of command strips 110, hundreds of command strips 110, etc.

The ruler 112 may be used in conjunction with the leveling tool 104 in order to mount the top hanging elements 108(1) to a structure, such as a wall, with an adhesive. In particular, markings on the ruler 112 serve as a visual aid so that the user can space the hanging elements 108(1) laterally on a structure at appropriate distances from one another. The distance, D2, between the markings on the ruler 112 (measured from the center of one marking to the center of an adjacent marking) may be based at least in part on the distance, D1, between laterally-aligned holes 116 (or perforations) of the piece of material 102. For example, the distance, D2, may be equal to or slightly greater than the distance, D1. Accordingly, the sizes of the ruler 112 and the size of the piece of material 102 is not necessarily drawn to scale in FIG. 1.

Although the clips 106 can be coupled to the pieces of material 102 in a nondestructive manner if used properly, the kit 100 may nevertheless include a repair tool 114 to repair a piece of material 102 if the piece of material 102 happens to become damaged (e.g., if the corner rips or tears). For example, a corner of a damaged piece of material 102 may be inserted into the repair tool 114 to align repair material (e.g., a replacement corner section) while attaching the repair material to the damaged piece of material 102.

FIG. 2 illustrates an example decoration 200 that can be created using the example kit 100 of FIG. 1. For purposes of illustration, the pieces of material 102 in FIG. 2 are depicted as translucent pieces of material so that the clips 106, the hanging elements 108, and the command strips 110 that would otherwise be occluded by the pieces of material 102 can be seen. The example decoration 200 of FIG. 2 is made up of six pieces of material 102(1), 102(2), 102(3), 102(4), 102(5), and 102(6), and each piece of material 102 is of the same size. As mentioned above, this is merely one example, as the pieces of material 102 may be of different sizes in other examples. For example, imagine an alternative configuration where the four pieces of material 102(1), 102(2), 102(4), and 102(5) were replaced by a single, larger piece of material 102. In this alternative configuration, the decoration 200 would utilize fewer clips 106 and hanging elements 108 to interconnect and hang the pieces of material 102. In the example of FIG. 2, the decoration 200 utilizes two inner clips 106(1), four corner clips 106(2)(A)-(D), and six edge clips 106(3) that are each coupled to at least one piece of material 102. For example, each corner clip 106(2)(A)-(D) is coupled to a single corner of a single piece of material 102, each edge clip 106(3) is coupled to two adjacent pieces of material 102 at their respective corners, and each inner clip 106(1) is coupled to four pieces of material 102 at their respective corners.

In the example of FIG. 2, the decoration 200 utilizes four top hanging elements 108(1), two bottom hanging elements 108(2), and six command strips 110. The corner clips 106(2)(A)-(D) and two of the edge clips 106(3) are slidingly engaged with corresponding hanging elements 108. The hanging elements 108 are mounted to a structure (not shown in FIG. 2). In this manner, the interconnected pieces of material 102(1)-(6) are suspended on the structure, such as a wall. As mentioned above, the pieces of material 102 may have portions of a photograph or another work of art printed thereon. Accordingly, when the pieces of material 102 are arranged in a particular arrangement, interconnected, and hung on a structure, the pieces of material 102 collectively create the decoration (e.g., the photograph, a photo collage, or the like). In some examples, the pieces of material 102 can have one or more colors of pigment or ink printed thereon, or the material itself can be of a uniform or variable color to create the decoration 200.

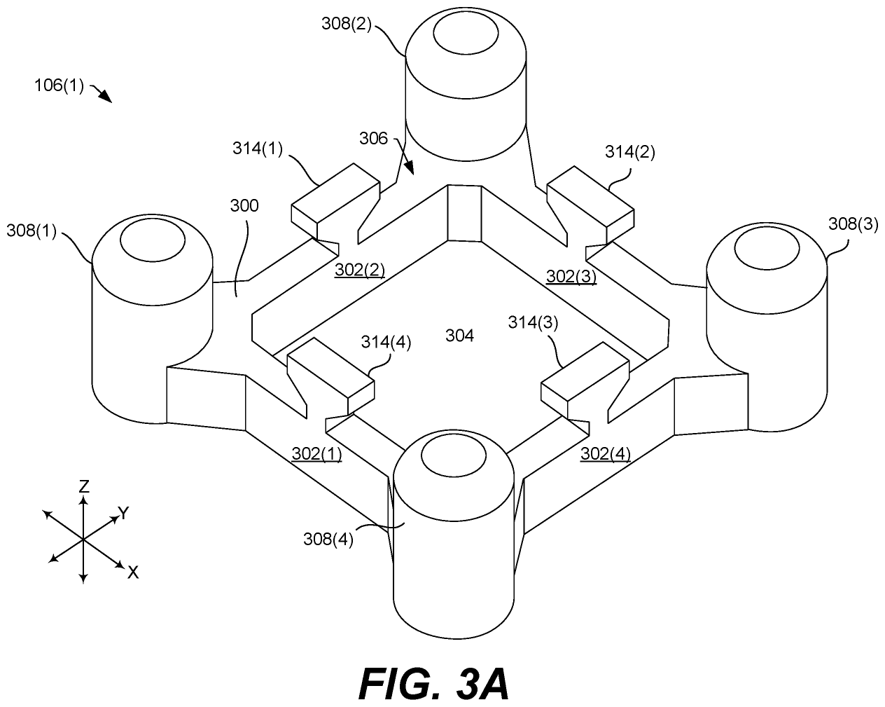

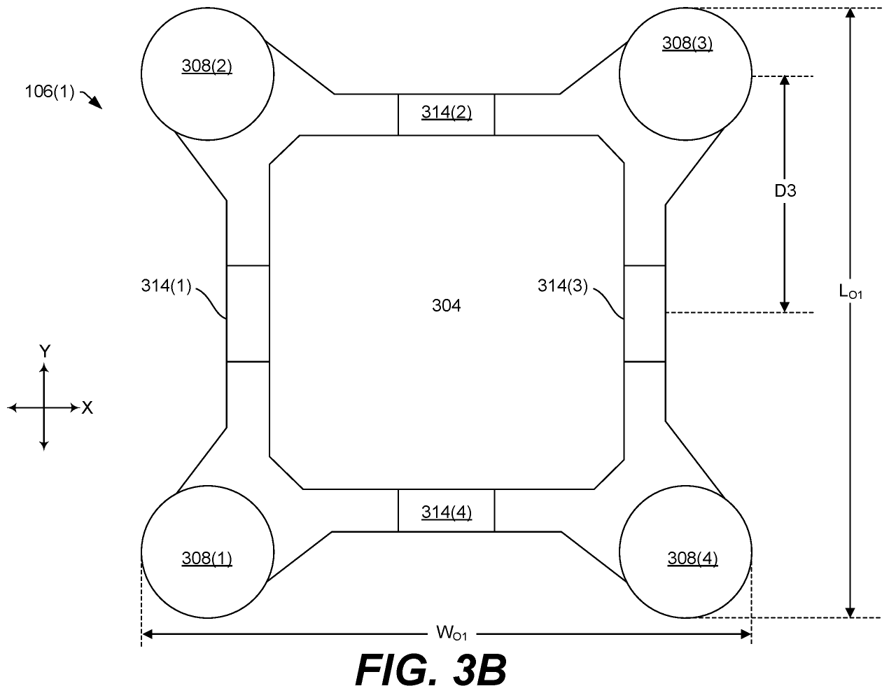

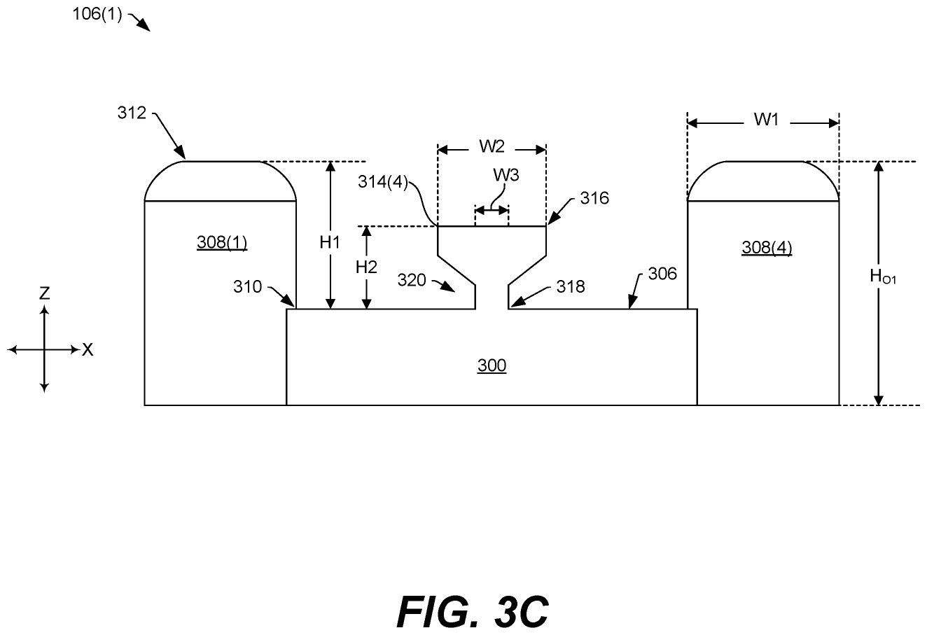

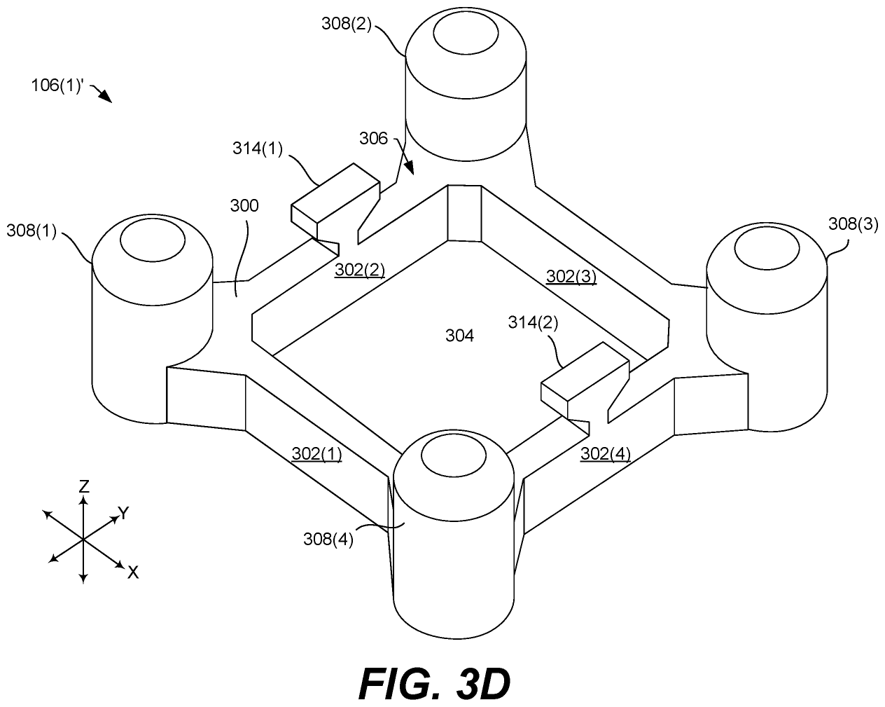

FIG. 3A illustrates a perspective view of an example inner clip 106(1) that may be included in the example kit 100 of FIG. 1, while FIG. 3B illustrates a front view of the example inner clip 106(1) and FIG. 3C illustrates a side view of the example inner clip 106(1). The inner clip 106(1) has a base 300, such as a planar base 300. In the example of FIG. 3A, the base 300 has four cross members 302(1), 302(2), 302(3), and 302(4) adjoined at four corners of the base 300 to form an opening 304 (e.g., a substantially square-shaped opening 304) in a middle of the base 300 bounded by the four cross members 302(1)-(4). The base 300 includes a planar front surface 306. The base 300 further includes four posts 308(1), 308(2), 308(3), and 308(4) located at the four corners of the base 300. Each post 308 extends from the planar front surface 306 of the base 300 and is configured to be inserted through a hole 116 defined in a piece of material 102. As shown in FIG. 3C, each post 308 is widest at a proximal end 310 of the post 308 where the post 308 meets the planar front surface 306 of the base 300. This maximum width, W1, of the post 308 is shown in FIG. 3C. In other words, the post 308 does not include a knob or a mushroom tip at the distal end 312 (or free end 312) of the post 308, which allows the user to couple a piece of material 102 to, and remove the piece of material 102 from, the inner clip 106(1) repeatedly without destroying the piece of material 102. In some examples, the post 308 has a uniform cross-section and/or a uniform width from the proximal end 310 to the distal end 312 of the post 308 (i.e., in the Z-direction). In the example depicted in FIG. 3C, however, the post 308 has a substantially rounded tip at the distal end 312 of the post 308.

The base 300 further includes four retaining projections 314(1), 314(2), 314(3), and 314(4) located at respective centers of the four cross members 302(1)-(4). Each retaining projection 314 extends from the planar front surface 306 of the base 300 and is configured to inhibit pieces of material 102 from sliding off of the posts 308 on the opposing sides of the retaining projection 314. For instance, as shown in FIG. 3C, a distal end 316 of each retaining projection 314 is wider than a proximal end 318 of the retaining projection 314 to create one or more notches 320 between the retaining projection 314 and the planar front surface 306 of the base 300. In other words, the width, W2, of the retaining projection 314 at the distal end 316 of the retaining projection 314 is greater than the width, W3, of the retaining projection 314 at the proximal end 318 of the retaining projection 314. It is to be appreciated that the shape of the retaining projection 314 can vary. For example, the shape of the retaining projection 314 depicted in FIG. 3C may be described as a “Y-shaped” retaining projection 314 with an angled side surface that is angled at an acute angle relative to the planar front surface 306 of the base 300. Alternatively, a “T-shaped” retaining projection 314 may have orthogonal side surfaces that are either perpendicular to, or parallel to, to the planar front surface 306 of the base 300. As another alternative, a “V-shaped” retaining projection 314 may have an angled side surface that extends from the proximal end 318 to the distal end 316 such that no portion of the opposing side surfaces of the retaining projection 314 is perpendicular to the planar front surface 306 of the base 300. In any of these examples, a notch(es) 320 may be created between the retaining projection 114 (at its sides) and the planar front surface 306 of the base 300. FIG. 3C depicts an example where the retaining projection 314 is symmetrical and, therefore, two notches 320 are created on opposing sides of the retaining projection 314 (i.e., a first notch 320 at a first side of the retaining projection 314, and a second notch 320 at a second side of the retaining projection 314 opposite the first side). When a piece of material 102 is disposed in a notch 320 and a post 308 is disposed through a hole 116 in the piece of material 102, the piece of material 102 is inhibited from sliding off of the post 308. Thus, the symmetrical retaining projection 314(4) shown in FIG. 3C is configured to inhibit two different pieces of material 102 from sliding off of their respective posts 308.

As shown in FIG. 3B, each retaining projection 314 is spaced a distance, D3, from an adjacent post 308. In other words, a post 308 may be disposed at a first location on the planar front surface 306 of the base 300, and a nearby retaining projection 314 may be disposed at a second location on the planar front surface 306 of the base 300, the second location being spaced a distance, D3, from the first location. This distance, D3, provides room for a user to slide a portion of a piece of material 102 into a notch 320 created by the retaining projection 314. In clips 106 with more than one post 308, such as the inner clip 106(1), a second post 308 may be disposed at a third location on the planar front surface 306 of the base 300, the third location being spaced the distance, D3, from the second location of the retaining projection 314. With the inner clip 106(1) in particular, each post 308 is spaced the distance, D3, from an adjacent retaining projection 314.

As shown in FIG. 3C, each post 308 is taller than each of the retaining projections 314, as measured from the planar front surface 306 of the base 300 to respective distal ends 312, 316 of the post 308 and the retaining projection 314. In other words, there is a height differential between a post 308 and a retaining projection 314 such that a height, H1, of the post 308 (as measured from the planar front surface 306 of the base 300 to the distal end 312 of the post 308) is greater than a height, H2, of the retaining projection 314 (as measured from the planar front surface 306 of the base 300 to the distal end 316 of the retaining projection 314). This height differential between H1 and H2 also inhibits the piece of material 102 from sliding off of the post 308.

The inner clip 106(1) may be of any suitable size. The overall dimensions (overall length, L_{O1}, overall width, W_{O1}, and overall height, Hoi) are shown in FIGS. 3B and 3C. In the example depicted in FIG. 3B, the overall length, L_{O1}, of the inner clip 106(1) may be equal to the overall width, W_{O1}, of the inner clip 106(1). In some examples, L_{O1} and W_{O1} may each be within a range of about 10 millimeters (mm) to 20 mm. In some examples, L_{O1} and W_{O1} may each be about 14.35 mm. In some examples, the overall height, Hoi, of the inner clip 106(1) may be within a range of about 2 mm to 8 mm. In some examples, Hoi may be about 5.05 mm. The shape of the inner clip 106(1) can vary as well. FIGS. 3A-3C depict a square-shaped inner clip 106(1), but other shapes are contemplated, such as a diamond-shaped inner clip 106(1).

With reference to FIG. 3D, there is shown an example of an inner clip 106(1)′ having two retaining projections 314(1) and 314(2) on opposite sides of the base 300 instead of four retaining projections 314. Said another way, the two retaining projections 314(1) and 314(2) of the inner clip 106(1)′ are located at respective centers of two opposing cross members 302(2) and 302(4) of the four cross members 302(1)-(4). A potential advantage of the example inner clip 106(1) shown in FIGS. 3A-3C is that rotation of the pieces of material 102 in the X-Y plane is inhibited more than with the example inner clip 106(1)′. That said, a potential advantage of the example inner clip 106(1)′ is that it may be easier for a user to couple a piece of material 102 to, and/or remove a piece of material 102 from, the inner clip 106(1)′ and/or there may be less of the inner clip 106(1)′ that is visible between the pieces of material 102 in the decoration 200.

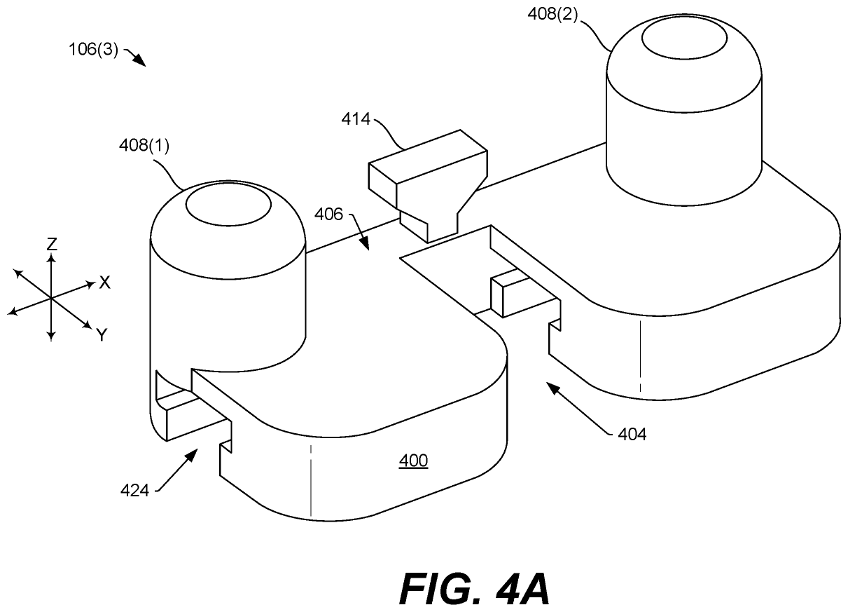

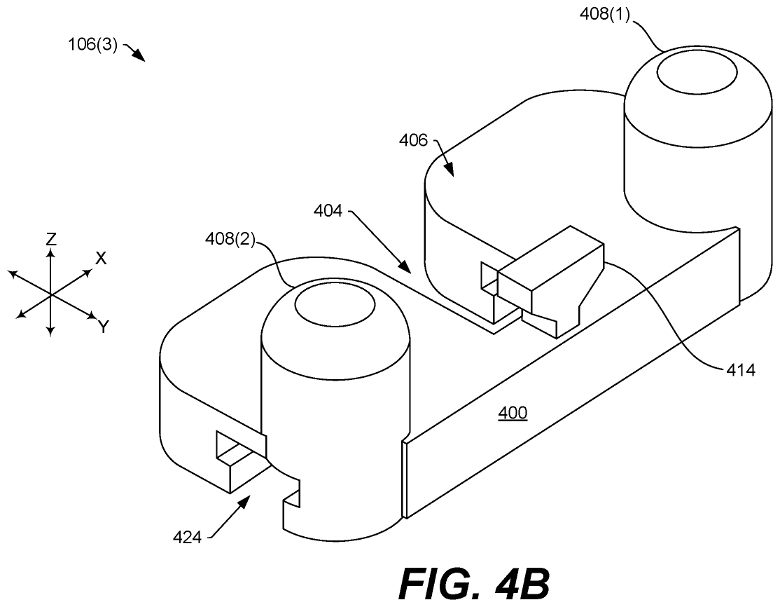

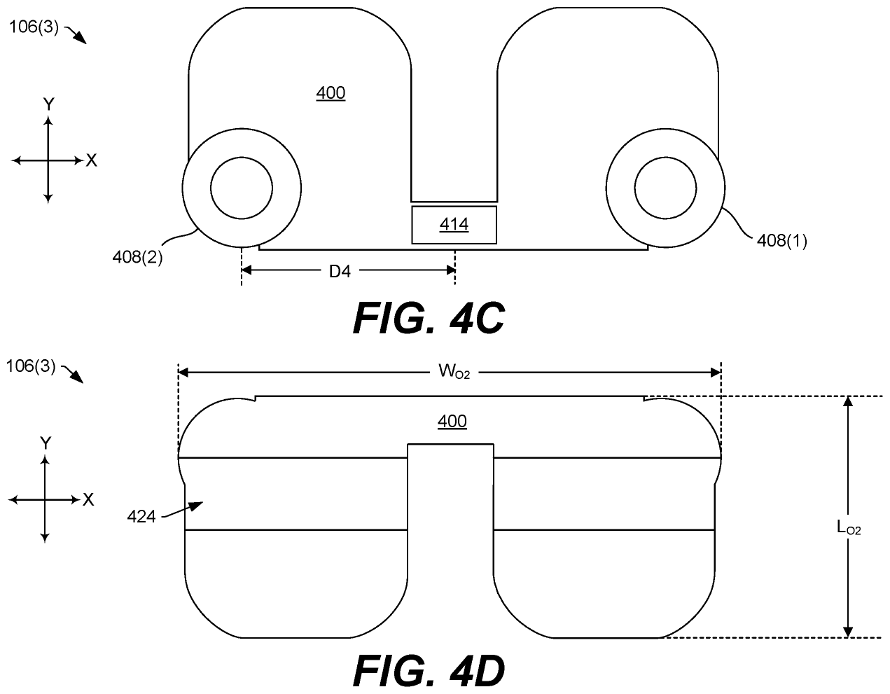

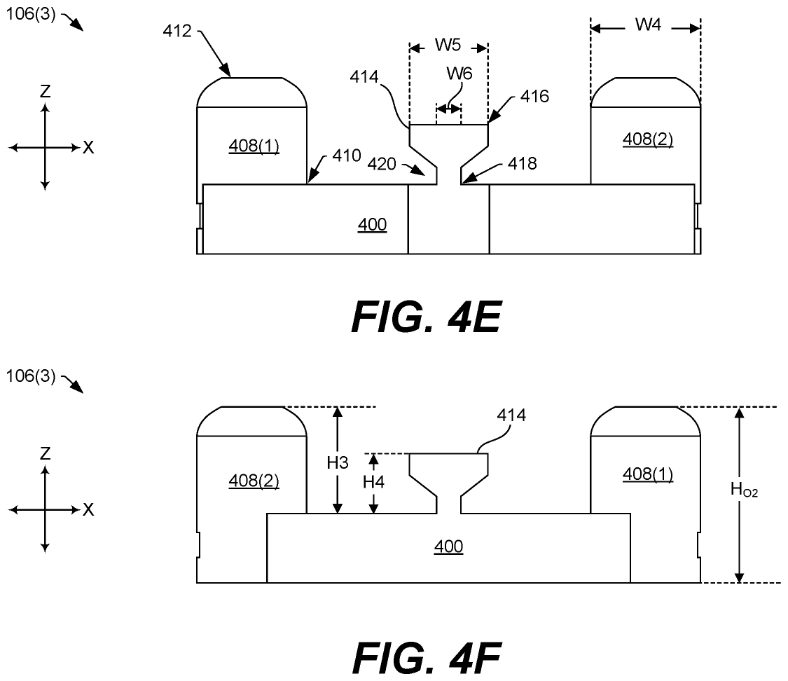

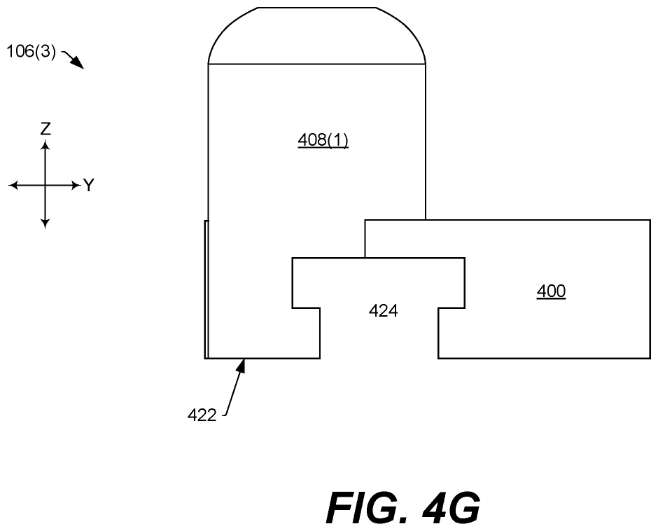

FIG. 4A illustrates a perspective view of an example edge clip 106(3) that may be included in the example kit 100 of FIG. 1, while FIG. 4B illustrates another perspective view of the example edge clip 106(3), FIG. 4C illustrates a front view of the example edge clip 106(3), FIG. 4D illustrates a back view of the example edge clip 106(3), and FIGS. 4E, 4F, and 4G illustrate various side views of the example edge clip 106(3). The edge clip 106(3) has a base 400, such as a planar base 400. In the example of FIG. 4A, the base 400 has a cutout 404 in a middle of the base 400 with two halves of the base 400 on opposing sides of the cutout 404. The base 400 includes a planar front surface 406. The base 400 further includes two posts 408(1) and 408(2) located at opposite ends of the base 400. Each post 408 extends from the planar front surface 406 of the base 400 and is configured to be inserted through a hole 116 defined in a piece of material 102. As shown in FIGS. 4E and 4F, each post 408 is widest at a proximal end 410 of the post 408 where the post 408 meets the planar front surface 406 of the base 400. This maximum width, W4, of the post 408 is shown in FIG. 4E. In other words, the post 408 does not include a knob or a mushroom tip at the distal end 412 (or free end 412) of the post 408, which allows the user to couple a piece of material 102 to, and remove the piece of material 102 from, the edge clip 106(3) repeatedly without destroying the piece of material 102. In some examples, the post 408 has a uniform cross-section and/or a uniform width from the proximal end 410 to the distal end 412 of the post 408 (i.e., in the Z-direction). In the example depicted in FIGS. 4E and 4F, however, the post 408 has a substantially rounded tip at the distal end 412 of the post 408.

The base 400 further includes a retaining projection 414 located at the middle of the base 400 (in the X-direction). The retaining projection 414 extends from the planar front surface 406 of the base 400 and is configured to inhibit pieces of material 102 from sliding off of the posts 408 on the opposing sides of the retaining projection 414. For instance, as shown in FIGS. 4E and 4F, a distal end 416 of the retaining projection 414 is wider than a proximal end 418 of the retaining projection 414 to create one or more notches 420 between the retaining projection 414 and the planar front surface 406 of the base 400. In other words, the width, W5, of the retaining projection 414 at the distal end 416 of the retaining projection 414 is greater than the width, W6, of the retaining projection 414 at the proximal end 418 of the retaining projection 414. As described above with respect to the retaining projection 314, it is to be appreciated that the shape of the retaining projection 414 can vary (e.g., a “Y-shaped” retaining projection 414, a “T-shaped” retaining projection 414, a “V-shaped” retaining projection 414, etc.) Furthermore, FIGS. 4E and 4F depict an example where the retaining projection 414 is symmetrical and, therefore, two notches 420 are created on opposing sides of the retaining projection 414 (i.e., a first notch 420 at a first side of the retaining projection 414, and a second notch 420 at a second side of the retaining projection 414 opposite the first side). When a piece of material 102 is disposed in a notch 420 and a post 408 is disposed through a hole 116 in the piece of material 102, the piece of material 102 is inhibited from sliding off of the post 408.

As shown in FIG. 4C, the retaining projection 414 is spaced a distance, D4, from an adjacent post 408. In other words, a post 408 may be disposed at a first location on the planar front surface 406 of the base 400, and the retaining projection 414 may be disposed at a second location on the planar front surface 406 of the base 400, the second location being spaced a distance, D4, from the first location. This distance, D4, provides room for a user to slide a portion of a piece of material 102 into a notch 420 created by the retaining projection 414.

As shown in FIG. 4F, each post 408 is taller than the retaining projection 414, as measured from the planar front surface 406 of the base 400 to respective distal ends 412, 416 of the post 408 and the retaining projection 414. In other words, there is a height differential between a post 408 and the retaining projection 414 such that a height, H3, of the post 408 (as measured from the planar front surface 406 of the base 400 to the distal end 412 of the post 408) is greater than a height, H4, of the retaining projection 414 (as measured from the planar front surface 406 of the base 400 to the distal end 416 of the retaining projection 414). This height differential between H3 and H4 also inhibits the piece of material 102 from sliding off of the post 408.

The edge clip 106(3) may be of any suitable size. The overall dimensions (overall length, L_{O2}, overall width, W_{O2}, and overall height, H_{O2}) are shown in FIGS. 4D and 4F. In the example depicted in FIG. 4D, the overall length, L_{O2}, of the edge clip 106(3) may be different than the overall width, W_{O2}, of the edge clip 106(3). In some examples, W_{O2} may be within a range of about 10 mm to 20 mm. In some examples, WO2 may be about 14.35 mm. In some examples, L_{O2} may be within a range of about 3 mm to 9 mm. In some examples, L_{O2} may be about 6.39 mm. In some examples, the overall height, H_{O2}, of the edge clip 106(3) may be within a range of about 2 mm to 8 mm. In some examples, H_{O2} may be about 5.05 mm. The shape of the edge clip 106(3) can vary as well. FIGS. 4A-4G depict a rectangular-shaped edge clip 106(3), but other shapes are contemplated.

The edge clip 106(3) may further include a planar back surface 422 opposite the planar front surface 406, and a straight groove 424 defined in the planar back surface 422. The straight groove 424 is configured to slidingly engage with a corresponding straight rail of a hanging element 108. The example of FIG. 4G depicts the straight groove 424 as having a T-shaped cross section. This allows the straight groove 424 to slidingly engage with a T-shaped straight rail of the hanging element 108. It is to be appreciated, however, that the straight groove 424 can have a cross section of a different shape, such as a dovetail-shaped (or substantially triangular-shaped) cross section, a Y-shaped cross section, or the like. These cross-sectional shapes prevent the edge clip 106(3) from sliding off of the straight rail of the hanging element 108 in the Z-direction. In other words, a user can remove the edge clip 106(3) from a hanging element 108 by sliding the edge clip 106(3) all the way off of the straight rail of the hanging element 108 in the X-direction, but a user is inhibited from removing the edge clip 106(3) from the hanging element 108 by simply pulling the edge clip 106(3) away from the hanging element 108 in the Z-direction. This is due to the cross-sectional shape of the straight groove 424 defined in the planar back surface 422 of the edge clip 106(3). In some examples, the straight groove 424 extends along the entire width (e.g., the overall width, Woz) of the edge clip 106(3), as shown in FIG. 4D.

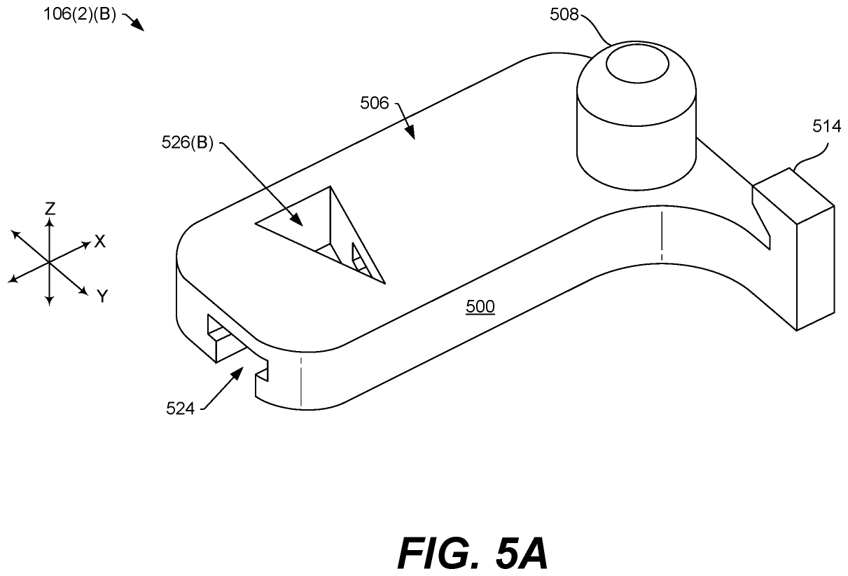

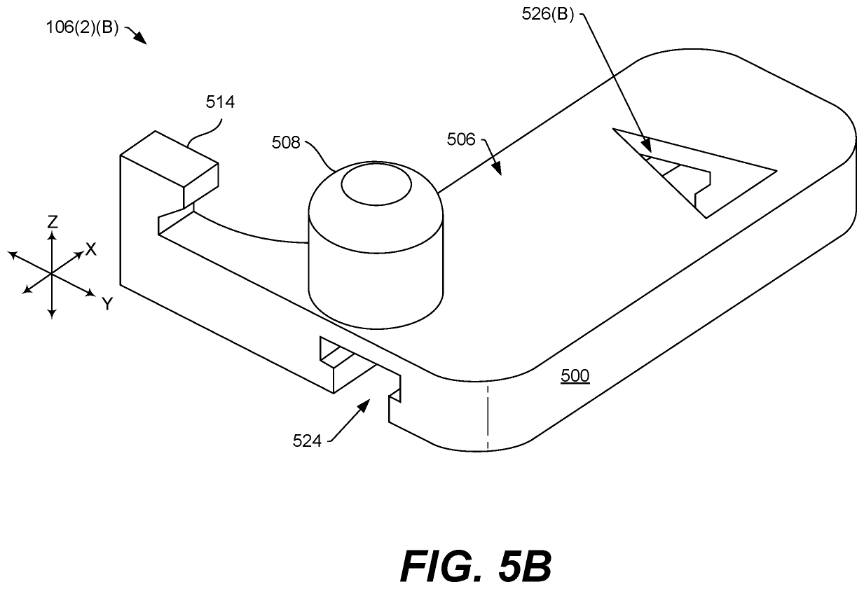

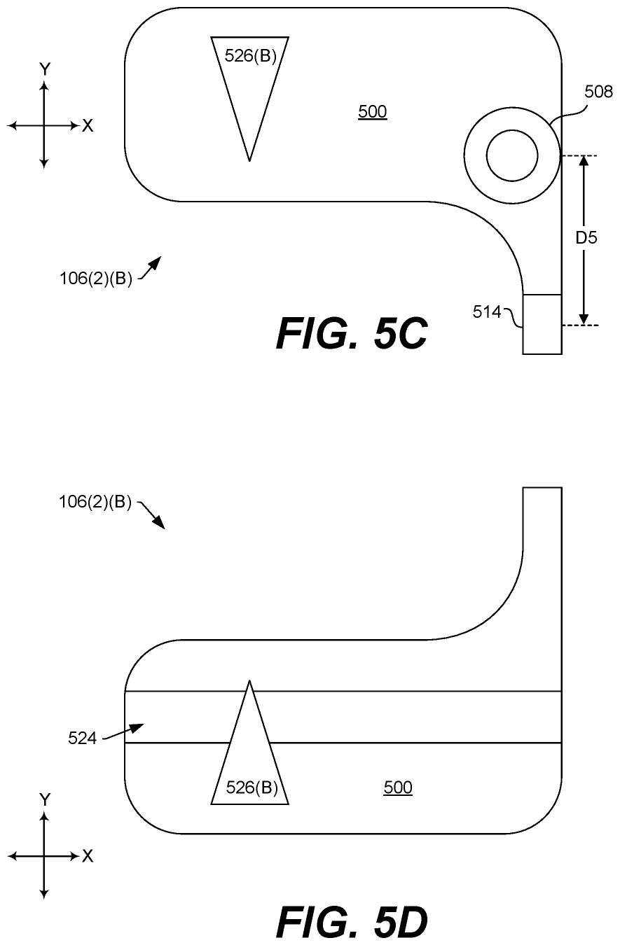

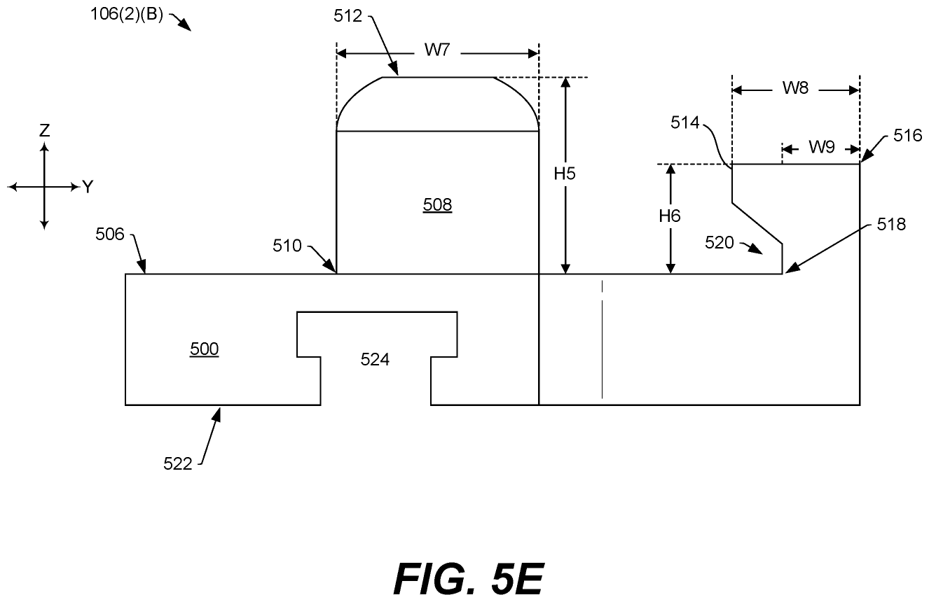

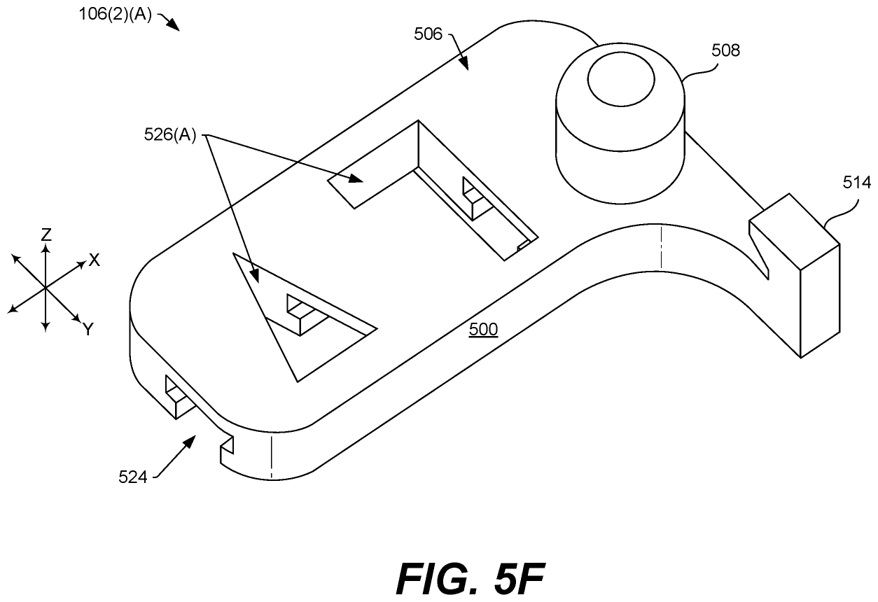

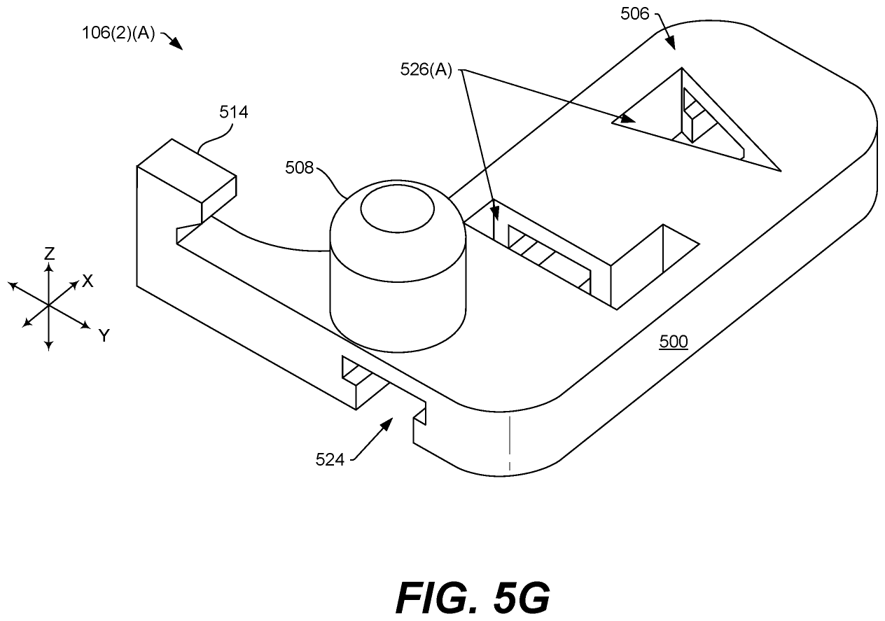

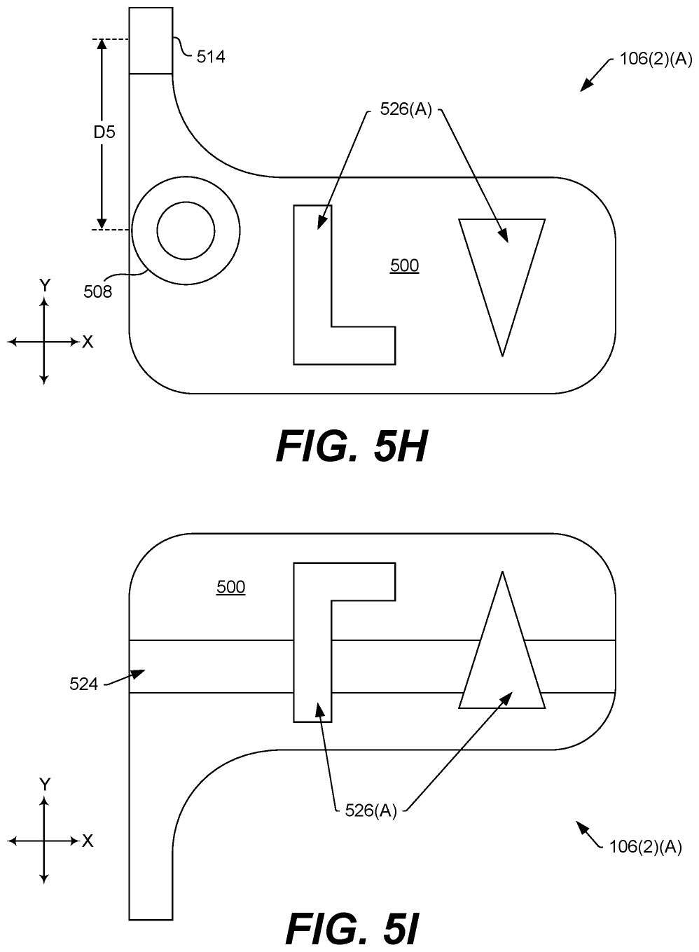

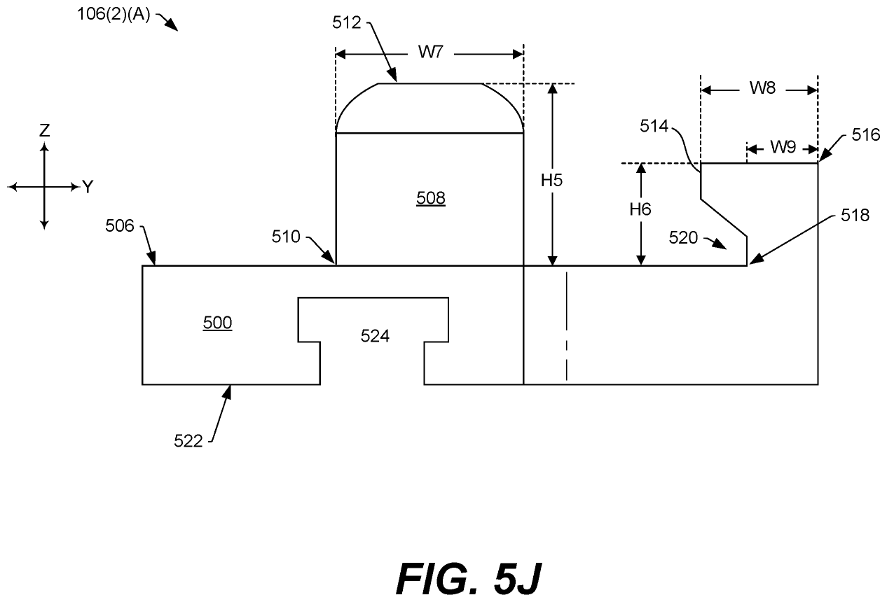

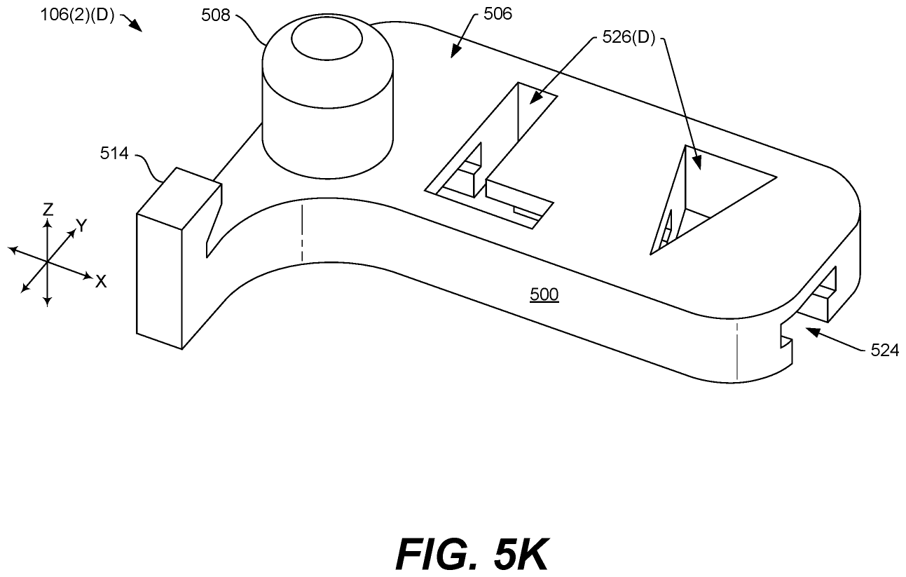

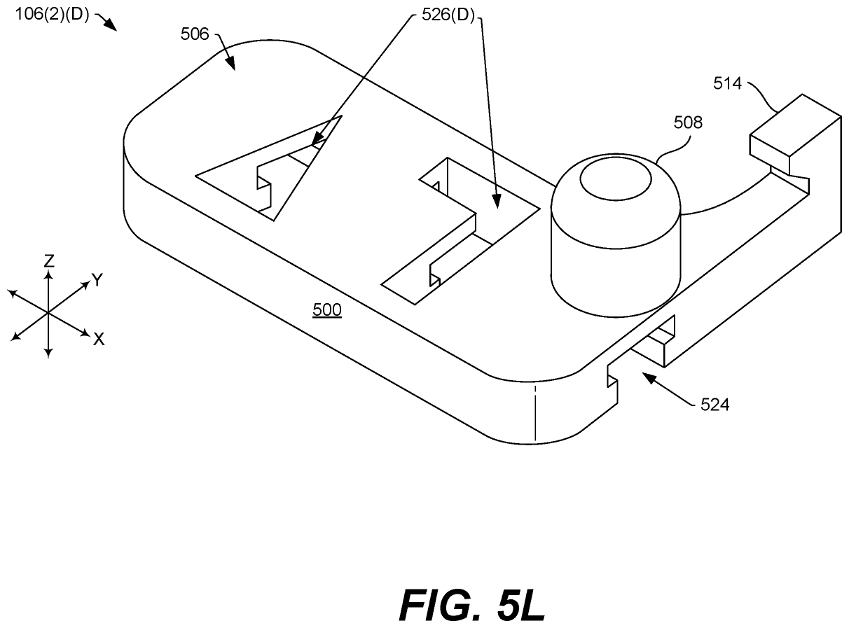

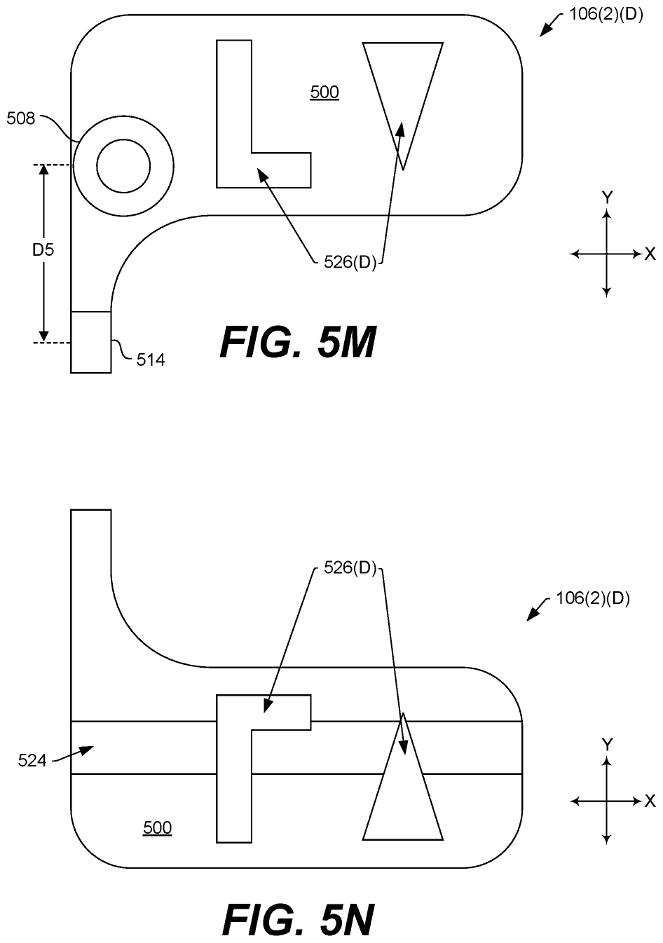

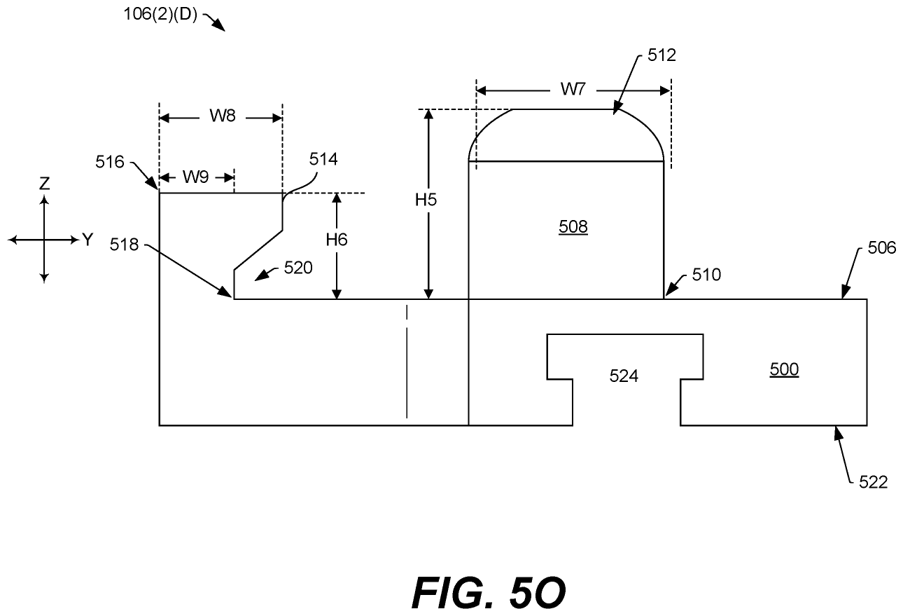

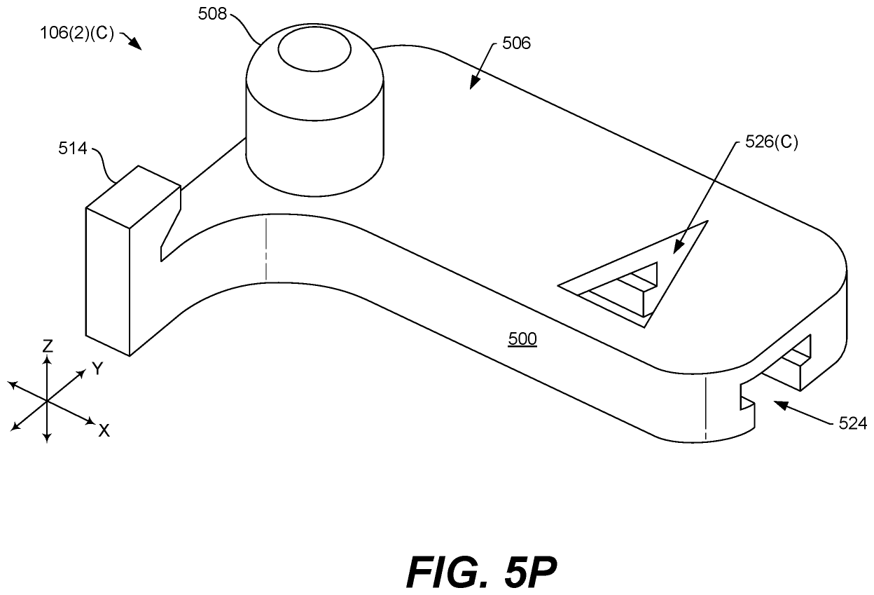

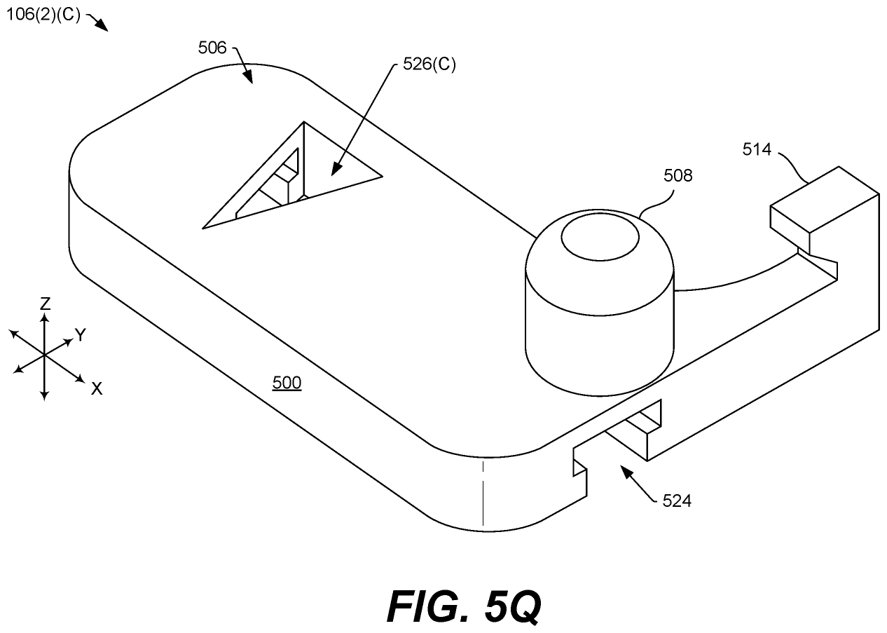

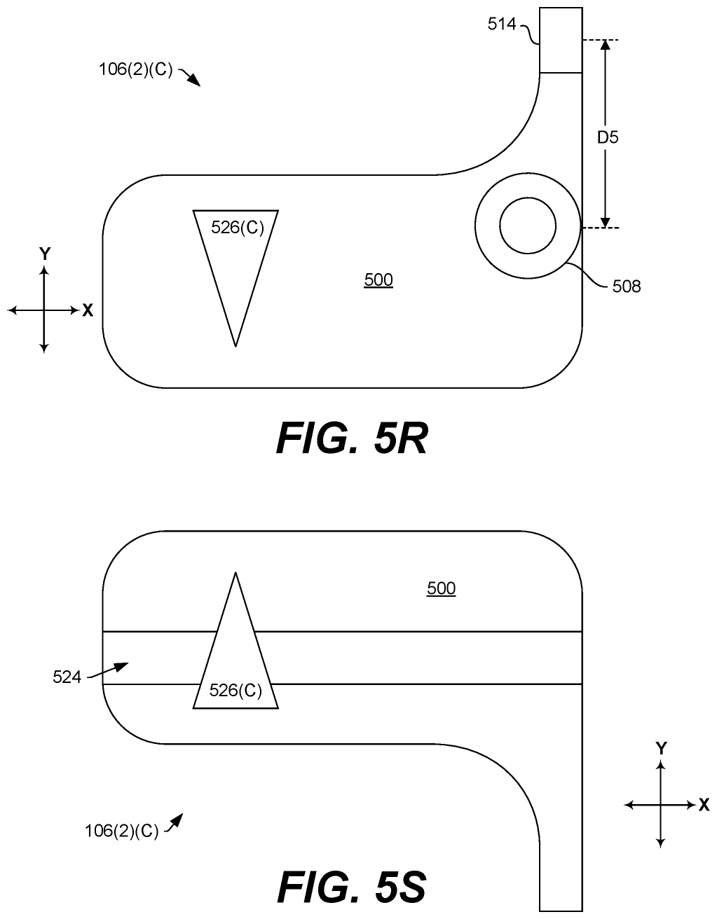

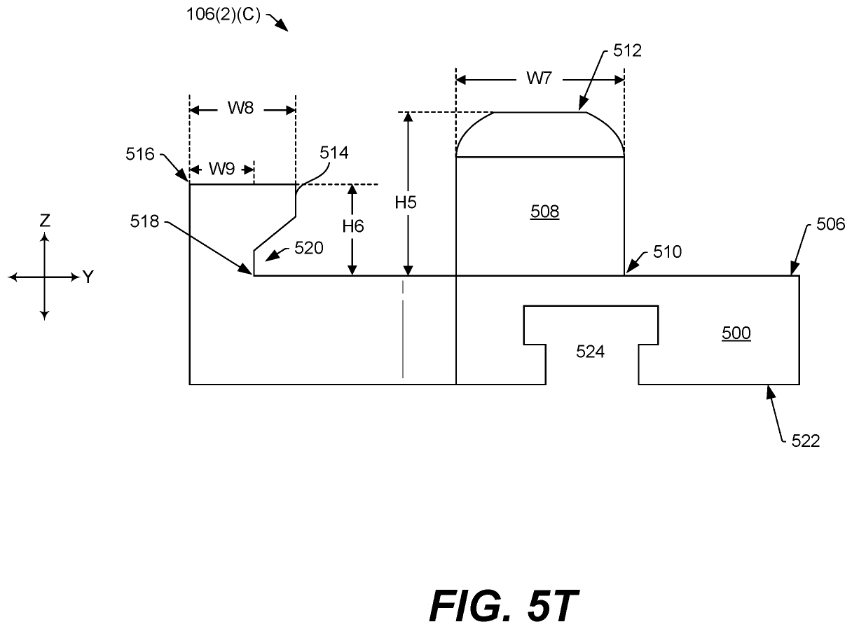

FIGS. 5A-5T illustrate various views of the example corner clips 106(2) that may be included in the example kit 100 of FIG. 1. FIG. 5A illustrates a perspective view of an example lower-right corner clip 106(2)(B), while FIG. 5B illustrates another perspective view of the example lower-right corner clip 106(2)(B), FIG. 5C illustrates a front view of the example lower-right corner clip 106(2)(B), FIG. 5D illustrates a back view of the example lower-right corner clip 106(2)(B), and FIG. 5E illustrates a side view of the example lower-right corner clip 106(2)(B). These same views are illustrated in FIGS. 5F-5J for the upper-left corner clip 106(2)(A), FIGS. 5K-5O for the lower-left corner clip 106(2)(D), and FIGS. 5P-5T for the upper-right corner clip 106(2)(C).

Each corner clip 106(2) has a base 500, such as a planar base 500. The base 500 includes a planar front surface 506. The base 500 further includes a post 508 located at one end of the base 500. The post 508 extends from the planar front surface 506 of the base 500 and is configured to be inserted through a hole 116 defined in a piece of material 102. As shown in FIGS. 5E, 5J, 5O, and 5T, the post 508 is widest at a proximal end 510 of the post 508 where the post 508 meets the planar front surface 506 of the base 500. This maximum width, W7, of the post 508 is shown in FIGS. 5E, 5J, 5O, and 5T. In other words, like the other clips 106, the post 508 of the corner clip 106(2) does not include a knob or a mushroom tip at the distal end 512 (or free end 512) of the post 508, which allows the user to couple a piece of material 102 to, and remove the piece of material 102 from, the corner clip 106(2) repeatedly without destroying the piece of material 102. In some examples, the post 508 has a uniform cross-section and/or a uniform width from the proximal end 510 to the distal end 512 of the post 508 (i.e., in the Z-direction). In the example depicted in FIGS. 5E, 5J, 5O, and 5T, however, the post 508 has a substantially rounded tip at the distal end 512 of the post 508.

The base 500 further includes a retaining projection 514 located at the same end of the base 500 as the post 508 (in the X-direction). The retaining projection 514 extends from the planar front surface 506 of the base 500 and is configured to inhibit pieces of material 102 from sliding off of the post 508. For instance, as shown in FIGS. 5E, 5J, 5O, and 5T, a distal end 516 of the retaining projection 514 is wider than a proximal end 518 of the retaining projection 514 to create one or more notches 520 between the retaining projection 514 and the planar front surface 506 of the base 500. In other words, the width, W8, of the retaining projection 514 at the distal end 516 of the retaining projection 514 is greater than the width, W9, of the retaining projection 514 at the proximal end 518 of the retaining projection 514. As described above with respect to the retaining projection 314, it is to be appreciated that the shape of the retaining projection 414 can vary. Furthermore, FIGS. 5E, 5J, 5O, and 5T depict an example where the retaining projection 514 is asymmetrical and, therefore, one notch 520 is created on a side of the retaining projection 514, unlike the symmetrical retaining projection 314 with two notches 320 on opposing sides of the retaining projection 314. In any case, when a piece of material 102 is disposed in the notch 520 and the post 508 is disposed through a hole 116 in the piece of material 102, the piece of material 102 is inhibited from sliding off of the post 508.

As shown in FIGS. 5C, 5H, 5M, and 5R, the retaining projection 514 is spaced a distance, D5, from the post 508. In other words, the post 508 may be disposed at a first location on the planar front surface 506 of the base 500, and the retaining projection 514 may be disposed at a second location on the planar front surface 506 of the base 500, the second location being spaced a distance, D5, from the first location. This distance, D5, provides room for a user to slide a portion of a piece of material 102 into a notch 520 created by the retaining projection 514.

As shown in FIGS. 5E, 5J, 5O, and 5T, the post 508 is taller than the retaining projection 514, as measured from the planar front surface 506 of the base 500 to respective distal ends 512, 516 of the post 508 and the retaining projection 514. In other words, there is a height differential between a post 508 and the retaining projection 514 such that a height, H5, of the post 508 (as measured from the planar front surface 506 of the base 500 to the distal end 512 of the post 508) is greater than a height, H6, of the retaining projection 514 (as measured from the planar front surface 506 of the base 500 to the distal end 516 of the retaining projection 514). This height differential between H5 and H6 also inhibits the piece of material 102 from sliding off of the post 508.

The individual corner clips 106(2) may be of any suitable size. In some examples, the overall dimensions of the individual corner clips 106(2) is similar to the overall dimensions (overall length, L_{O2}, overall width, W_{O2}, and overall height, H_{O2}) of the edge clip 106(3). The shape of the individual corner clips 106(2) can vary as well. FIGS. 5A-5T depict rectangular-shaped corner clips 106(2), but other shapes are contemplated.

The individual corner clips 106(2) may further include a planar back surface 522 opposite the planar front surface 506, and a straight groove 524 defined in the planar back surface 522. The straight groove 524 is configured to slidingly engage with a corresponding straight rail of a hanging element 108. The example of FIGS. 5E, 5O, and 5T depicts the straight groove 524 as having a T-shaped cross section. As described above with reference to the straight groove 424, this allows the straight groove 524 to slidingly engage with a T-shaped straight rail of the hanging element 108, and it prevents the corner clip 106(2) from sliding off of the straight rail of the hanging element 108 in the Z-direction, but the straight groove 524 can have a cross section of a different shape (e.g., a dovetail-shaped (or substantially triangular-shaped) cross section, a Y-shaped cross section, etc.). In some examples, the straight groove 524 extends along the entire width (e.g., the overall width) of the corner clip 106(2), as shown in FIGS. 5D, SI, 5N, and 5S.

Each corner clip 106(2) is also shown as having a visual indicator 526(A), 526(B), 526(C), and 526(D) of the orientation that the corner clip 106(2) is to be in when coupled to a hanging element 108. For example, the visual indicators 526 may include an arrow to indicate which side of the corner clip 106(2) should face down, although the arrow may indicate any other suitable direction, such as up, left, or right. Accordingly, by including an arrow in the visual indicator 526, a user knows how to orient the corner clip 106(2). Additionally, or alternatively, the visual indicators 526 may include a letter, L, to indicate whether the corner clip 106(3) should be on the left side of the decoration 200, although the letter may indicate any other suitable side of the decoration 200, such as top (e.g., “T”), bottom (e.g., “B”), or right (e.g., “R”). The visual indicator 526 may be a cutout defined in the corner clip 106(2) as depicted in FIGS. 5A-5T. Alternatively, the visual indicator 526 may be painted on, etched in a surface (e.g., the planar front surface 506), and/or the visual indicator 526 may be a sticker that is adhered to a surface (e.g., the planar front surface 506).

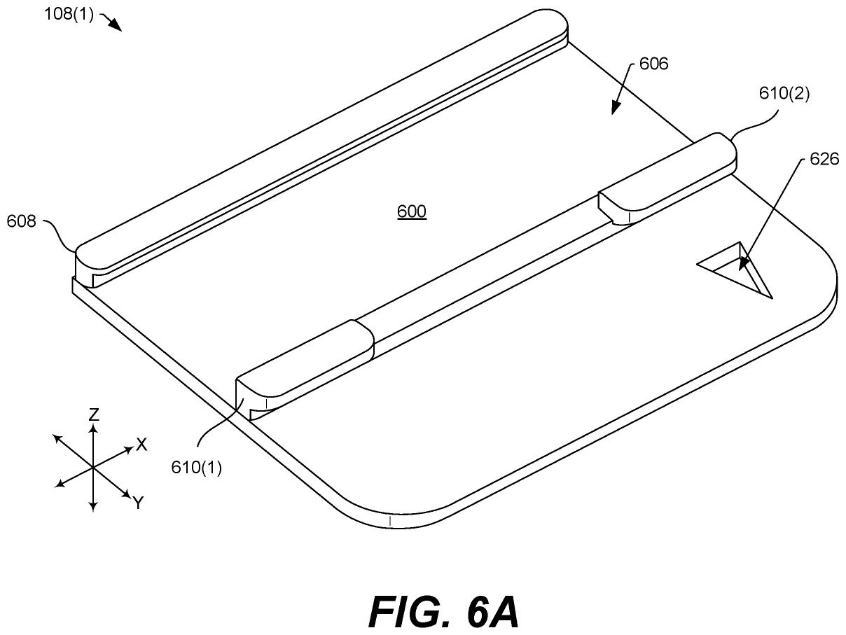

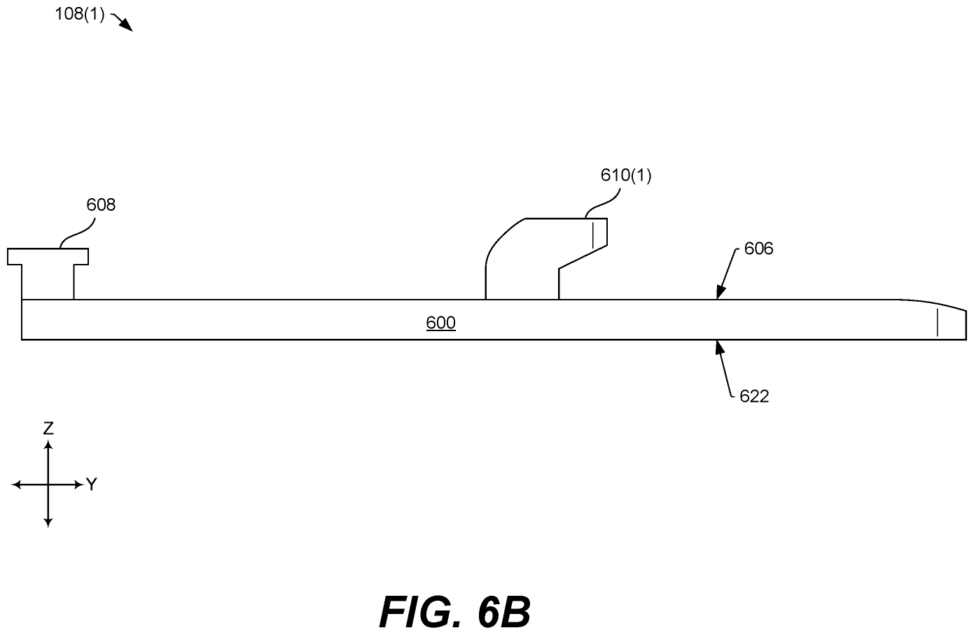

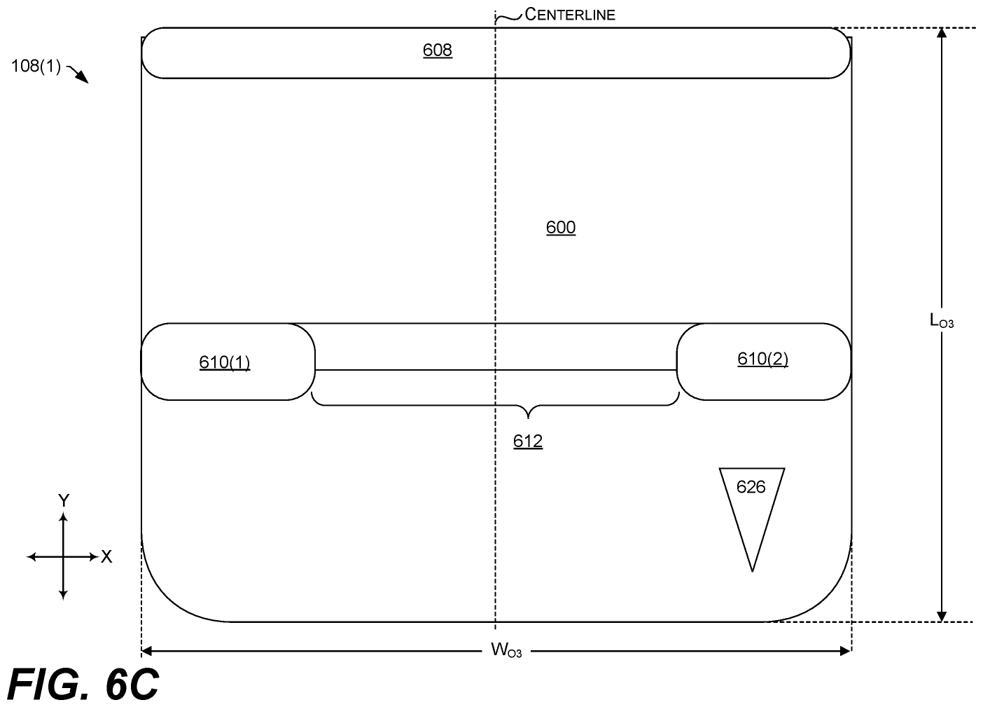

FIG. 6A illustrates a perspective view of an example top hanging element 108(1) that may be included in the example kit 100 of FIG. 1, while FIG. 6B illustrates a side view of the example top hanging element 108(1), and FIG. 6C illustrates a front view of the example top hanging element 108(1). The top hanging element 108(1) has a base 600, such as a planar base 600. The base 600 includes a planar front surface 606. The base 600 further includes a straight rail 608 located at a periphery of the base 600 and extending along a side of the base 600, such as a top side of the base 600 when the top hanging element 108(1) is mounted to a wall. The straight rail 608 also extends from the planar front surface 606 of the base 600 and is configured to slidingly engage with a straight groove defined in a clip, such as the straight groove 424 the edge clip 106(3) or the straight groove 524 of the corner clips 106(2)(A), 106(2)(C). The example of FIG. 6B depicts the straight rail 608 as having a T-shaped cross section. This allows the straight rail 608 of the top hanging element 108(1) to slidingly engage with a T-shaped straight groove 424, 524 of a clip 106(2), 106(3). It is to be appreciated, however, that the straight rail 608 can have a cross section of a different shape, such as a dovetail-shaped (or substantially triangular-shaped) cross section, a Y-shaped cross section, or the like. These cross-sectional shapes prevent a clip 106(2), 106(3) from sliding off of the straight rail 608 of the top hanging element 108(1) in the Z-direction. In other words, as described above, a user can remove a clip 106(2), 106(3) from the top hanging element 108(1) by sliding the clip 106(2), 106(3) all the way off of the straight rail 608 of the top hanging element 108(1) in the X-direction, but a user is inhibited from removing the clip 106(2), 106(3) from the top hanging element 108(1) by simply pulling the clip 106(2), 106(3) away from the top hanging element 108(1) in the Z-direction. This is due to the cross-sectional shape of the straight rail 608 of the top hanging element 108(1). In some examples, the straight rail 608 extends along the entire width (e.g., the overall width, W_{O3}) of the top hanging element 108(1), as shown in FIG. 6C.

The base 600 further includes a planar back surface 622 opposite the planar front surface 606. The planar back surface 622 is configured to be mounted to a structure (e.g., a wall) with an adhesive. The command strip 110 described herein is an example of an adhesive that can be used to mount the top hanging element 108(1) to a structure, such as a wall. As described above, one side of the command strip 110 can be adhered to the planar back surface 622 of the top hanging element 108(1), and the other side of the command strip 110 can be adhered to the structure (e.g., the wall).

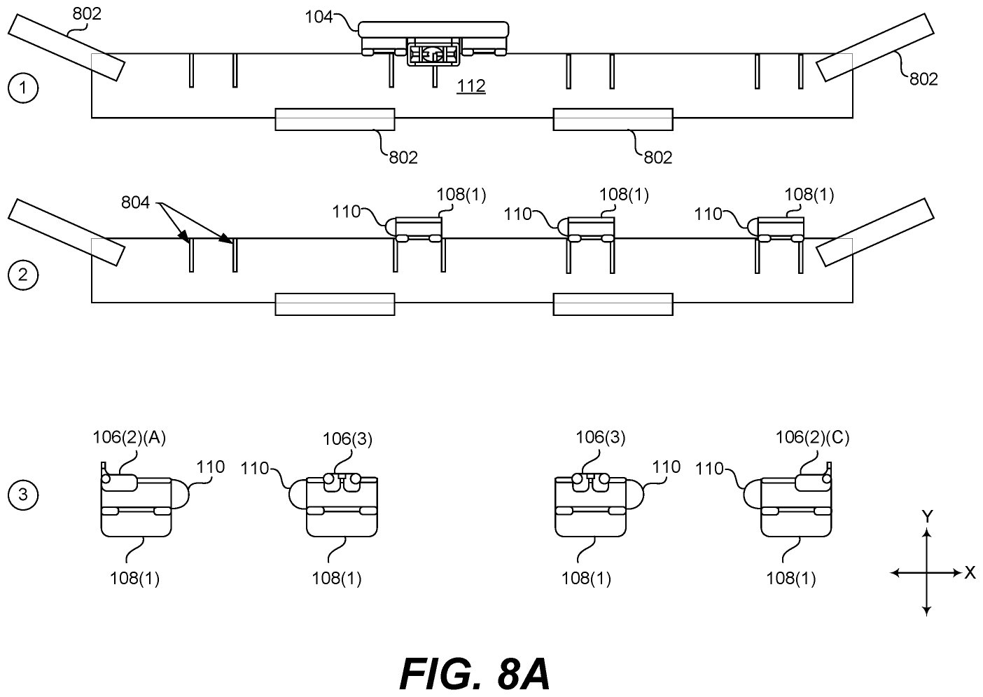

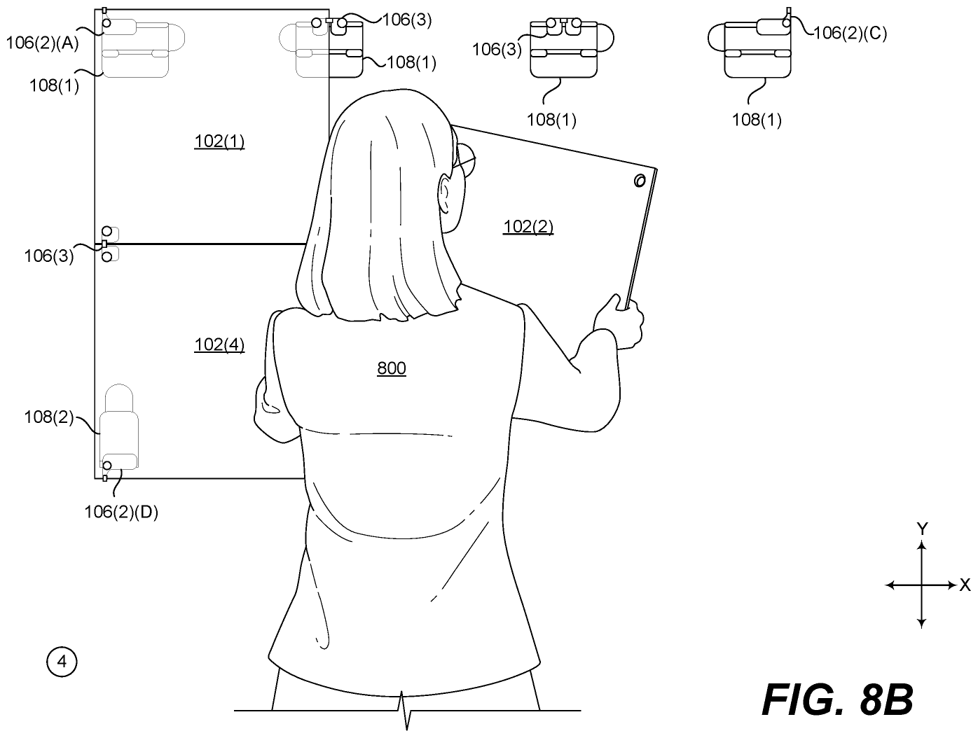

The base 600 of the top hanging element 108(1) further includes one or more hooks 610, such as a pair of hooks 610(1) and 610(2), although one hook 610 or more than two hooks 610 may be implemented. Furthermore, instead of a hook(s) 610, the base 600 of the top hanging element 108(1) may include a ridge(s) or any other suitable type of projection(s) extending from the base 600. In some examples, the pair of hooks 610(1) and 610(2) are equidistant from a center line of the base 600 that is orthogonal to the straight rail 608, as illustrated in FIG. 6C. In some examples, the pair of hooks 610(1) and 610(2) are equidistant from the straight rail 608, as illustrated in FIG. 6C. In some examples, the pair of hooks 610(1) and 610(2) curve away from the straight rail 608, as shown in FIG. 6B. In these examples, the hooks 610(1) and 610(2) are configured to be hooked onto, or to be set atop, a top edge of the ruler 112 for purposes of mounting the top hanging element 108(1) to a wall, for example. This is described in more detail below with respect to FIG. 8A. The symmetrical arrangement of the hooks 610(1) and 610(2) about the centerline of the base 600 and from the straight rail 608 ensures that the top hanging element 108(1) is level on the structure (e.g., the wall) to which it is mounted. This is because a user can use the leveling tool 104 with the ruler 112 to ensure that the ruler 112 is level, and then, when the top hanging elements 108(1) are hooked onto the top edge of the ruler 112 using the hooks 610(1) and 610(2), the top hanging element 108(1) is naturally leveled along with the ruler 112.

In some examples, the pair of hooks 610(1) and 610(2) are spaced apart with a gap 612 between the pair of hooks 610(1) and 610(2). The gap 612 between the pair of hooks 610(1) and 610(2) provides the user with a visual confirmation that the top hanging element 108(1) is resting properly against the top edge of the ruler 112.

The top hanging element 108(1) may be of any suitable size. The overall dimensions (overall length, L_{O3}, and overall width, W_{O3}) are shown in FIG. 6C. In some examples, W_{O3} may be within a range of about 20 mm to 35 mm. In some examples, W_{O3} may be about 28.01 mm. In some examples, L_{O3} may be within a range of about 15 mm to 30 mm. In some examples, Loa may be about 23.36 mm. The shape of the top hanging element 108(1) can vary as well. FIGS. 6A-6C depict a rectangular-shaped top hanging element 108(1), but other shapes are contemplated.

The top hanging element 108(1) is also shown as having a visual indicator 626 of the orientation that the top hanging element 108(1) is to be in when mounted to a structure, such as a wall. For example, the visual indicator 626 may include an arrow to indicate which side of the top hanging element 108(1) should face down, although the arrow may indicate any other suitable direction, such as up, left, or right. Accordingly, by including an arrow in the visual indicator 626, a user knows how to orient the top hanging element 108(1). The visual indicator 626 may be a cutout defined in the top hanging element 108(1) as depicted in FIGS. 6A and 6C. Alternatively, the visual indicator 626 may be painted on, etched in a surface (e.g., the planar front surface 606), and/or the visual indicator 626 may be a sticker that is adhered to a surface (e.g., the planar front surface 606).

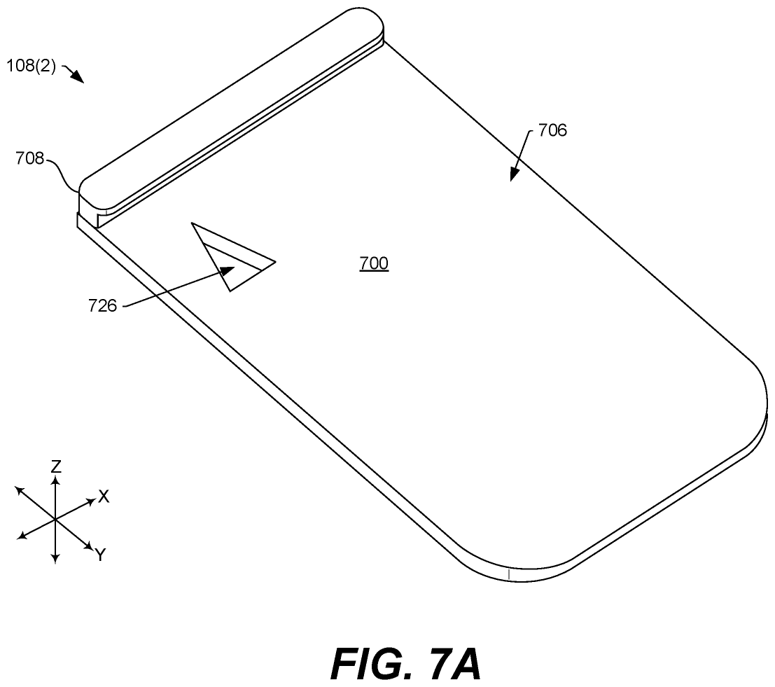

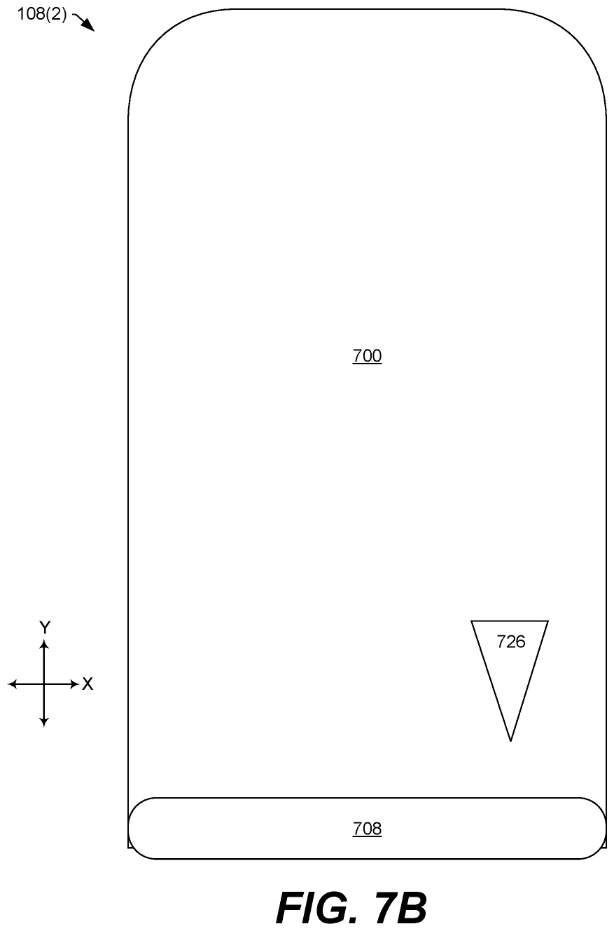

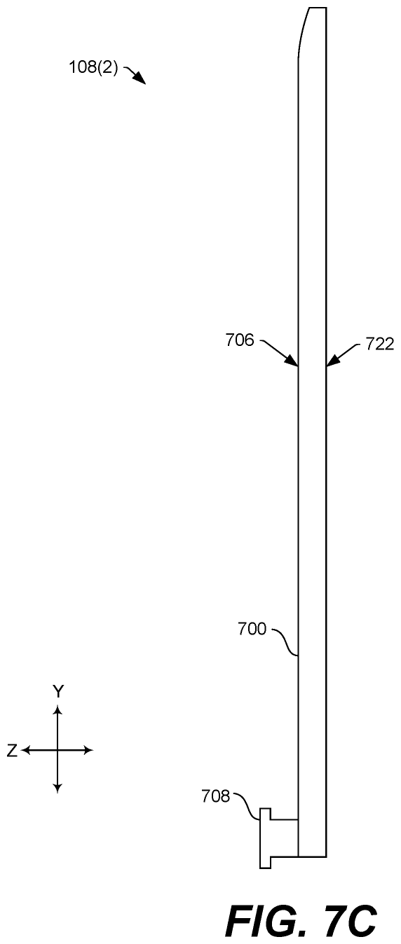

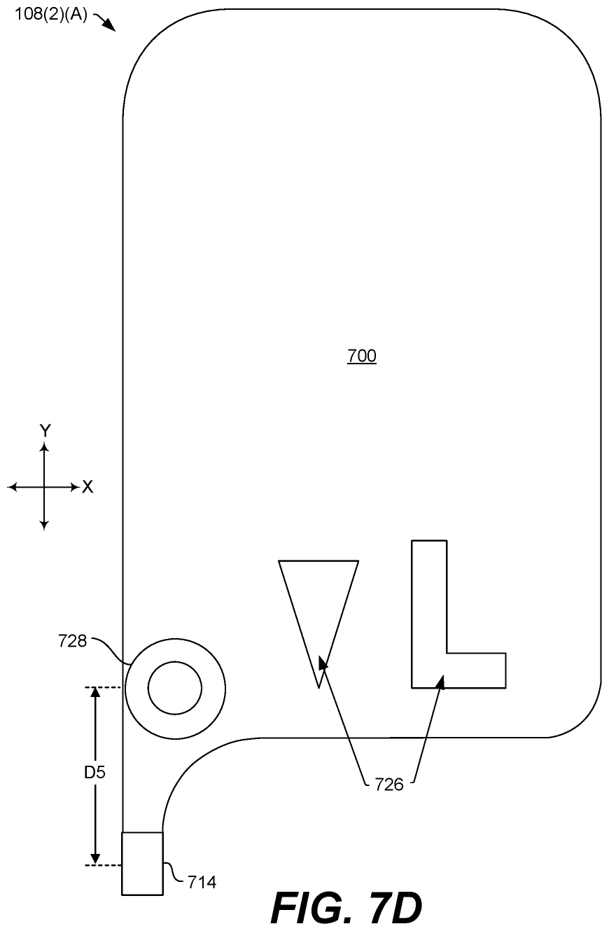

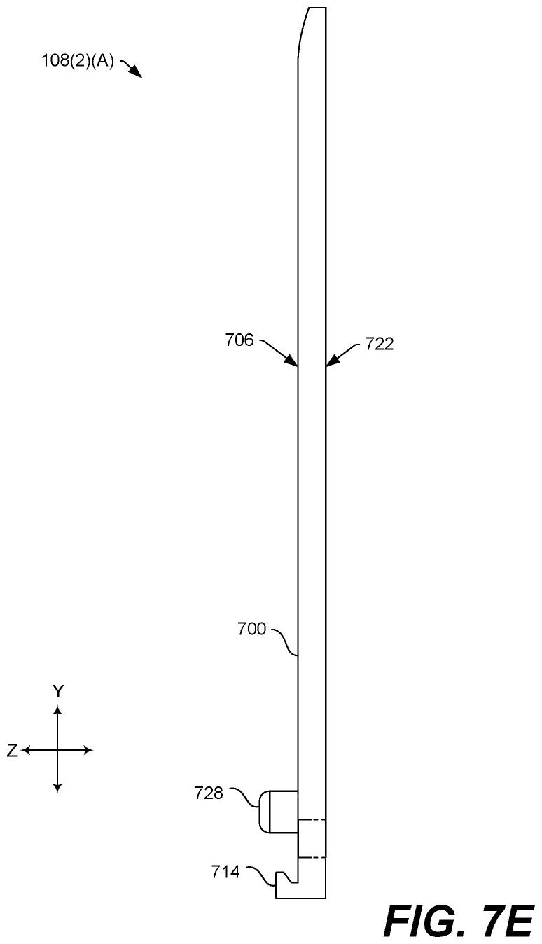

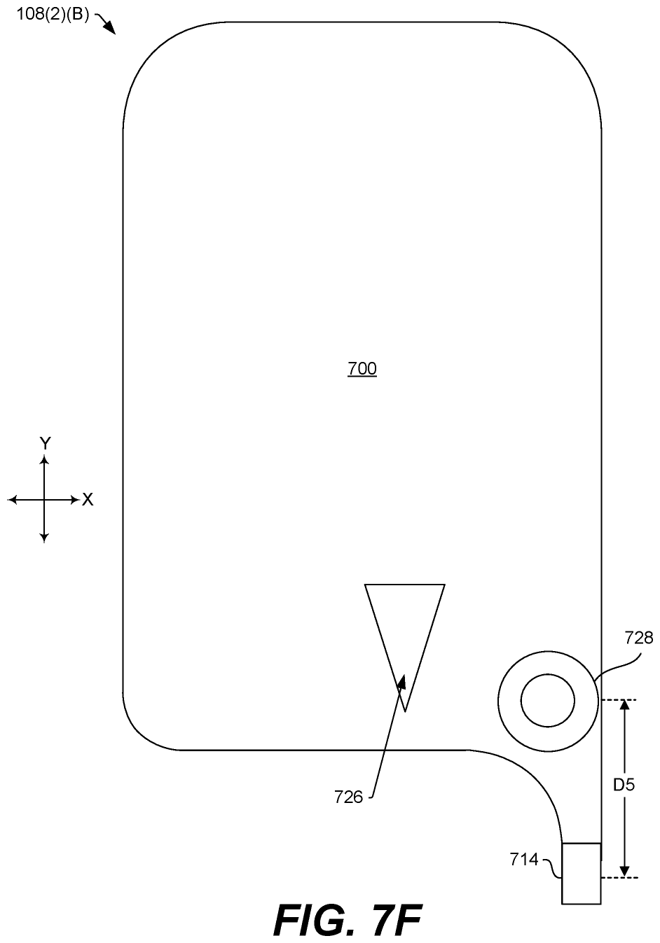

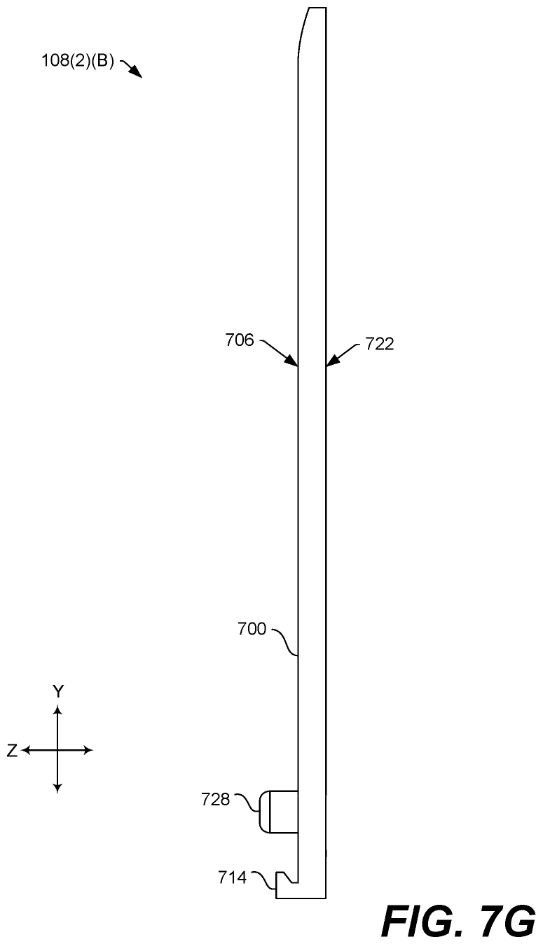

FIG. 7A illustrates a perspective view of an example bottom hanging element 108(2) that may be included in the example kit 100 of FIG. 1, while FIG. 7B illustrates a front view of the example bottom hanging element 108(2), and FIG. 7C illustrates a side view of the example bottom hanging element 108(2). The bottom hanging element 108(2) has a base 700, such as a planar base 700. The base 700 includes a planar front surface 706. The base 700 further includes a straight rail 708 located at a periphery of the base 700 and extending along a side of the base 700, such as a bottom side of the base 700 when the bottom hanging element 108(2) is mounted to a wall. The straight rail 708 also extends from the planar front surface 706 of the base 700 and is configured to slidingly engage with a straight groove defined in a clip, such as the straight groove 524 of the corner clips 106(2)(B), 106(2)(D). The example of FIG. 7C depicts the straight rail 708 as having a T-shaped cross section. This allows the straight rail 708 of the bottom hanging element 108(2) to slidingly engage with a T-shaped straight groove 524 of a clip 106(2). It is to be appreciated, however, that the straight rail 708 can have a cross section of a different shape, such as a dovetail-shaped (or substantially triangular-shaped) cross section, a Y-shaped cross section, or the like. These cross-sectional shapes prevent a clip 106(2) from sliding off of the straight rail 708 of the bottom hanging element 108(2) in the Z-direction. In other words, as described above, a user can remove a clip 106(2) from the bottom hanging element 108(2) by sliding the clip 106(2) all the way off of the straight rail 708 of the bottom hanging element 108(2) in the X-direction, but a user is inhibited from removing the clip 106(2) from the bottom hanging element 108(2) by simply pulling the clip 106(2) away from the bottom hanging element 108(2) in the Z-direction. This is due to the cross-sectional shape of the straight rail 708 of the bottom hanging element 108(2). In some examples, the straight rail 708 extends along the entire width (e.g., the overall width) of the bottom hanging element 108(2), as shown in FIG. 7B.

The base 700 further includes a planar back surface 722 opposite the planar front surface 706. The planar back surface 722 is configured to be mounted to a structure (e.g., a wall) with an adhesive. The command strip 110 described herein is an example of an adhesive that can be used to mount the bottom hanging element 108(2) to a structure, such as a wall. As described above, one side of the command strip 110 can be adhered to the planar back surface 722 of the bottom hanging element 108(2), and the other side of the command strip 110 can be adhered to the structure (e.g., the wall).

The bottom hanging element 108(2) is also shown as having a visual indicator 726 of the orientation that the bottom hanging element 108(2) is to be in when mounted to a structure, such as a wall. For example, the visual indicator 726 may include an arrow to indicate which side of the bottom hanging element 108(2) should face down, although the arrow may indicate any other suitable direction, such as up, left, or right. Accordingly, by including an arrow in the visual indicator 726, a user knows how to orient the bottom hanging element 108(2). The visual indicator 726 may be a cutout defined in the bottom hanging element 108(2) as depicted in FIGS. 7A and 7B. Alternatively, the visual indicator 726 may be painted on, etched in a surface (e.g., the planar front surface 706), and/or the visual indicator 726 may be a sticker that is adhered to a surface (e.g., the planar front surface 706).

FIG. 7D illustrates a front view of another example bottom hanging element 108(2)(A) without a straight rail, but with an integrated post 728 and retaining projection 714, while FIG. 7E illustrates a side view of the example bottom hanging element 108(2)(A). The bottom hanging element 108(2)(A) shown in FIGS. 7D and 7E is an example of a bottom-left hanging element 108(2)(A). The bottom hanging element 108(2)(A) has a base 700, such as a planar base 700. The base 700 includes a planar front surface 706, and a planar back surface 722, similar to the other bottom hanging element 108(2) described herein. However, in contrast to the previously-described bottom hanging element 108(2), the bottom hanging element 108(2)(A) does not include a straight rail. Instead, the base 700 includes a post 728 located at one end of the base 700. The post 728 extends from the planar front surface 706 of the base 700 and is configured to be inserted through a hole 116 defined in a piece of material 102. As with the clips 106, the post 728 is widest at a proximal end of the post 728 where the post 728 meets the planar front surface 706 of the base 700. In other words, the post 728 does not include a knob or a mushroom tip at the distal end (or free end) of the post 728, which allows the user to couple a piece of material 102 to, and remove the piece of material 102 from, the bottom hanging element 108(2)(A) repeatedly without destroying the piece of material 102. In some examples, the post 728 has a uniform cross-section and/or a uniform width from the proximal end to the distal end of the post 728 (i.e., in the Z-direction). In the example depicted in FIG. 7E, however, the post 728 has a substantially rounded tip at the distal end of the post 728.

The base 700 of the bottom hanging element 108(2)(A) further includes a retaining projection 714 located at the same end of the base 700 as the post 728. In the example of FIG. 7D, the post 728 and retaining projection 714 are located at or near a bottom-left corner of the bottom hanging element 108(2)(A), with the retaining projection 714 below the post 728 when the bottom hanging element 108(2)(A) is mounted on a structure, such as a wall. The retaining projection 714 extends from the planar front surface 706 of the base 700 and is configured to inhibit pieces of material 102 from sliding off of the post 728. For instance, as shown in FIG. 7E, a distal end of the retaining projection 714 is wider than a proximal end of the retaining projection 714 to create one or more notches between the retaining projection 714 and the planar front surface 706 of the base 700, as described with respect to the clips 106 herein. As described above with respect to the retaining projection 314, it is to be appreciated that the shape of the retaining projection 714 can vary. Furthermore, FIG. 7E depicts an example where the retaining projection 714 is asymmetrical (in the Y-direction) and, therefore, one notch is created on a side of the retaining projection 714, unlike the symmetrical retaining projection 314 with dual notches 320 on opposing sides of the retaining projection 314.

As shown in FIG. 7D, the retaining projection 714 is spaced a distance, D6, from the post 728. In other words, the post 728 may be disposed at a first location on the planar front surface 706 of the base 700, and the retaining projection 714 may be disposed at a second location on the planar front surface 706 of the base 700, the second location being spaced a distance, D6, from the first location. This distance, D6, provides room for a user to slide a portion of a piece of material 102 into a notch created by the retaining projection 714.

FIGS. 7F and 7G illustrate front and side views, respectively, of another example bottom hanging element 108(2)(B) without a straight rail, but with an integrated post 728 and retaining projection 714. The bottom hanging element 108(2)(B) is similar to the bottom hanging element 108(2)(A), except that the bottom hanging element 108(2)(B) shown in FIGS. 7F and 7G is a bottom-right hanging element 108(2)(B) with the post 728 and the retaining projection 714 located at or near the bottom-right corner of the bottom hanging element 108(2)(B), which is on the opposite side (in the X-direction) to that of the post 728 and the retaining projection 114 included in the bottom-left hanging element 108(2)(A). Both bottom hanging elements 108(2)(A) and 108(2)(B) may have visual indicators 726 of the orientation that the bottom hanging elements 108(2)(A) and 108(2)(B) are to be in when mounted to a structure, such as a wall. The example bottom hanging elements 108(2)(A) and 108(2)(B) depicted in FIGS. 7D to 7G provide an alternative bottom hanging element 108(2) that does not require a clip 106 to be coupled thereto because features of the clips 106 described herein are integrated into the bottom hanging elements 108(2)(A) and 108(2)(B); namely, a post 728 and a retaining projection 714.

FIGS. 8A and 8B illustrate example steps of interconnecting and hanging pieces of material 102. The process of interconnecting and hanging pieces of material 102 illustrated in FIGS. 8A and 8B may utilize the systems described herein, such as the kit 100 and/or at least some of the components that are described as being included in the kit 100. At Step 1 (in FIG. 8A), a user 800 (shown in FIG. 8B) can place tape 802 on the ends of the ruler 112 and on the bottom of the ruler 112 every few feet (e.g., every 1.5 feet), adhere the ruler 112 to a structure (e.g., a wall) using the tape 802, and adjust the orientation of the ruler 112 while using the leveling tool 104 resting on a top edge of the ruler 112 to verify that the ruler 112 is level. In some examples, the user 800 can place tape 802 on the structure (e.g., the wall) to mark the left and right ends where the user 800 wants to locate a decoration (e.g., the decoration 200) on the structure (e.g., the wall), and then the user 800 can position the ruler 112 (and the leveling tool 104 resting thereon) between the marked ends. When the ruler 112 is level on the structure (e.g., the wall), the user 800 can slide his/her hand across the ruler 112 to make sure the ruler 112 is lying flat against the structure (e.g., the wall) with no wrinkles (e.g., the ruler 112 may be a flexible strip of paper). Although a ruler 112 in the form of a flexible strip of paper is contemplated, it is to be appreciated that the ruler 112 may be a flexible strip of poly paper material, or a flexible strip of material other than a paper material, such as a flexible polymer material. Alternatively, the ruler 112 may be a rigid, or semi-rigid material, such as a ruler 112 made of metal, wood, or any other suitable material. In some examples, a rigid, or semi-rigid ruler 112 may be collapsible (e.g., with joints) for easy packaging in the kit 100. Furthermore, although the ruler 112 is shown as having markings 804, it is to be appreciated that the ruler 112 may not have markings, such as the markings 804, in which case the ruler 112 may function as a mounting tool and not a ruler per se. After completing Step 1, the user 800 will understand that the top of the decoration will be aligned with the top of the leveling tool 104 (when the leveling tool 104 is resting on the top edge of the ruler 112, as shown in Step 1 of FIG. 8A).

At Step 2, the user 800 may adhere one side of the command strips 110 to the respective planar back surfaces 622 of the top hanging elements 108(1) (e.g., near the tops of the top hanging elements 108(1)), and rest the top hanging elements 108(1) on the top edge of the ruler 112 between the pairs of markings 804 on the ruler 112. There should be one more top hanging element 108(1) than the number of pieces of material 102 in a given row. Each of the top hanging elements 108(1) will be level if the ruler 112 is level, which ensures that the pieces of material 102 will not buckle and will be flush against the clips 106. The user 800 can verify that the top hanging elements 108(1) are level using a something flat (e.g., a flat, rectangular stick, such as a yard stick) resting on top of the top hanging elements 108(1). If the flat object does not touch three sequential top hanging elements 108(1), the user 800 can adjust the orientation of the ruler 112 and/or the position and/or orientation of the individual top hanging element 108(1) until they are level. After peeling the liners away from the other side of the command strips 110 on the backs of the top hanging elements 108(1), the user 800 can press the top hanging elements 108(1) against the structure (e.g., the wall) to rigidly mount the top hanging elements 108(1) to the structure (e.g., the wall) using the command strips 110.

At Step 3, the user 800 can remove the ruler 112 and the tape 802 from the structure (e.g., the wall), and slide the upper-left corner clip 106(2)(A), the edge clips 106(3), and the upper-right corner clip 106(2)(C) onto the respective top hanging elements 108(1). That is, the user 800 may slidingly engage the respective straight grooves 424, 524 of the clips 106(2), 106(3) with the respective straight rails 608 of the top hanging elements 108(1).

At Step 4 (shown in FIG. 8B), the user 800 can couple pieces of material 102, one-by-one, to the clips 106 of the kit 100 for purposes of interconnecting and hanging the pieces of material 102. For example, starting at upper-left, the user 800 can couple a piece of material 102(1) to the upper-left corner clip 106(2)(A) and to the edge clip 106(3) on the adjacent top hanging element 108(1). The sliding engagement between the clips 106(2), 106(3) and the top hanging elements 108(1) allows the clips 106(2), 106(3) to slide from side-to-side while remaining coupled to the top hanging elements 108(1). This allows the user 800 to couple the pieces of material 102 to the clips 106(2), 106(3) without damaging the pieces of material 102 in the process (e.g., without tearing the card stock). After hanging the upper-left piece of material 102, the user 800 can continue interconnecting pieces of material 102 horizontally along a row, or vertically along a column. For example, the user 800 can use another edge clip 106(3) and an inner clip 106(1) (not shown in FIG. 8B) to interconnect the piece of material 102(1) and the piece of material 102(4). If the second row is the bottom row, then the user 800 can also mount a bottom hanging element 108(2) to the structure (e.g., the wall) using adhesive (e.g., another command strip 110), slide a lower-left corner clip 106(2)(D) onto the bottom hanging element 108(2), and couple the piece of material 102(4) to the lower-left corner clip 106(2)(D), as described herein. Otherwise, the edge clips 106(3) and inner clips 106(1) can be used to add more rows, as desired. The user 800 in FIG. 8B is about to couple the piece of material 102(2) to the edge clips 106(3) on the middle two top hanging elements 108(1), and to the inner clip 106(1) (not shown in FIG. 8B) to interconnect the pieces of material 102(1), 102(2), and 102(4), as well as hang them on the structure (e.g., the wall). The user 800 may continue interconnecting and hanging pieces of material 102 as illustrated in Step 4 until all of the pieces of material 102 are interconnected and hung on the structure (e.g., the wall), which may result in the decoration 200 shown in FIG. 2, or another decoration. It should also be appreciated that the pieces of material 102 in FIG. 8B are depicted as translucent pieces of material so that the clips 106, the hanging elements 108, and the command strips 110 that would otherwise be occluded by the pieces of material 102 can be seen.

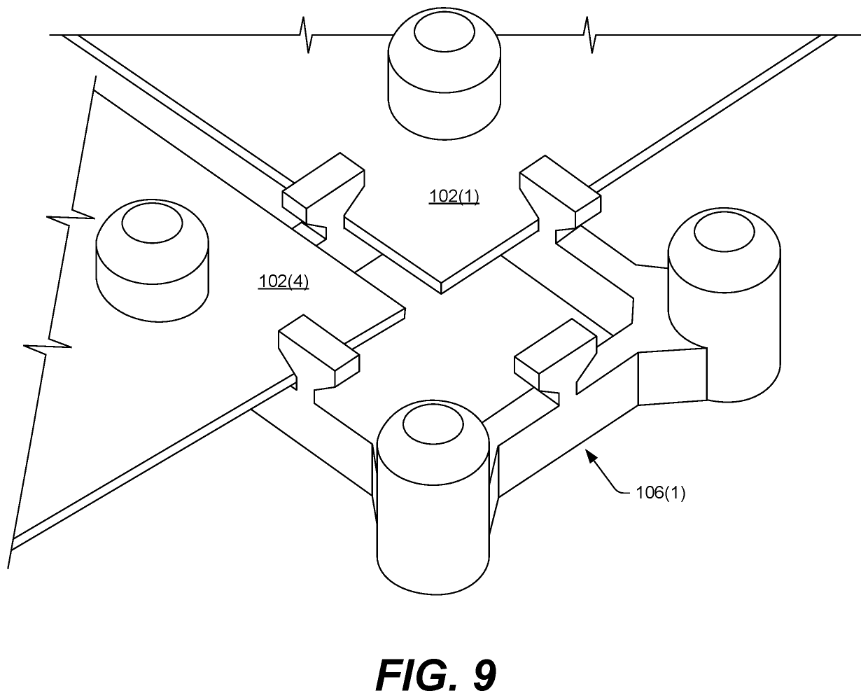

FIG. 9 illustrates a piece of material 102(4) being coupled to an inner clip 106(1). The inner clip 106(1) may be used to interconnect multiple pieces of material 102. FIG. 9 shows a first piece of material 102(1) already coupled to the inner clip 106(1) and a second piece of material 102(4) in the process of being coupled to the inner clip 106(1). In particular, a user 800 may orient the piece of material 102(4) at an angle relative to the X-Y plane of the inner clip 106(1) while positioning respective portions of the piece of material 102(4) in the notches 320 between the retaining projection 314 and the planar front surface 306 of the base 300 of the inner clip 106(1), and then the user 800 can slide the piece of material 102(4) over the post 308 until the post 308 is disposed through the hole 116 defined in the piece of material 102(4) and the piece of material 102(4) is laying flat against the inner clip 106(1). These steps can be performed in reverse order in order to remove the piece of material 102(4) from the inner clip 106(1) without destroying the piece of material 102(4), and the steps can be repeated with additional pieces of material 102 to continue coupling pieces of material 102 to the inner clip 106(1). A similar technique can be used to couple a piece of material 102 to any of the clips 106 described herein.

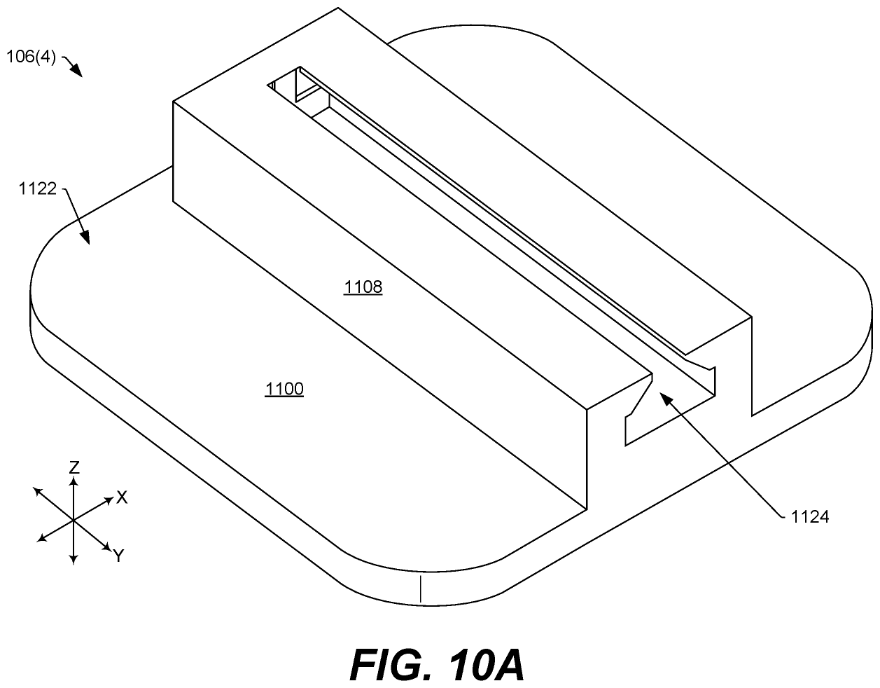

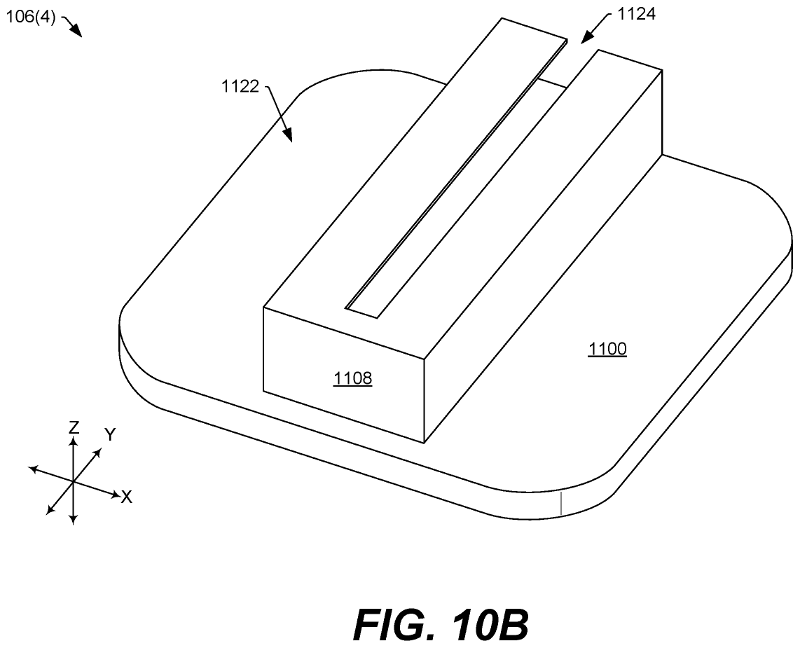

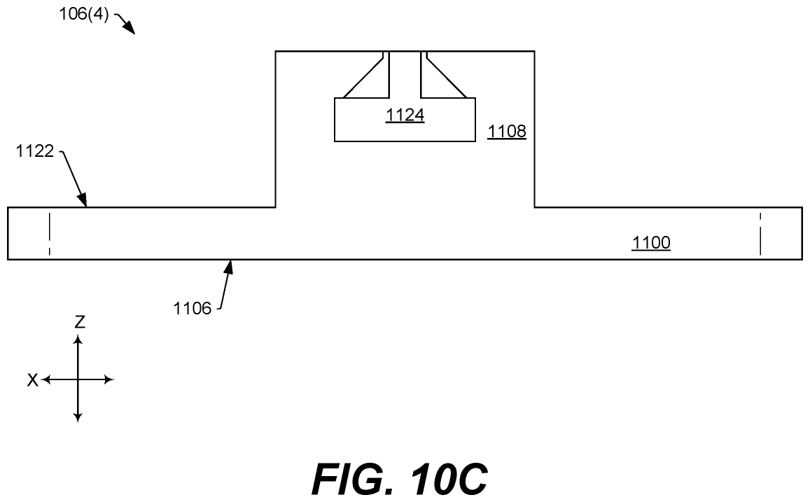

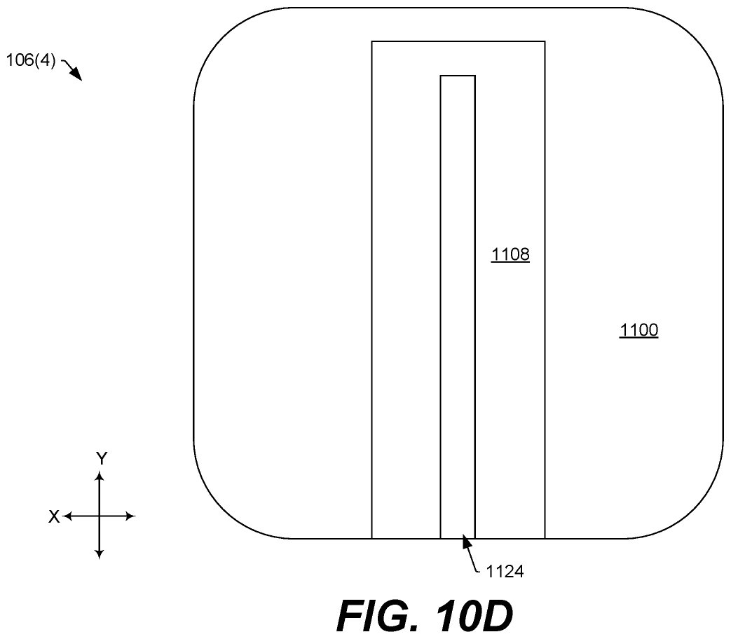

FIG. 10A illustrates a perspective view of an example locking clip 106(4) that may be included in the example kit 100 of FIG. 1, while FIG. 10B illustrates another perspective view of the example locking clip 106(4), FIG. 10C illustrates a side view of the example locking clip 106(4), and FIG. 10D illustrates a back view of the example locking clip 106(4). The locking clip 106(4) has a base 1100, such as a planar base 1100. The base 1100 may include a planar back surface 1122, and an elongate projection 1108 extending from the planar back surface 1122 and extending along a middle of the base 1100 from one side of the locking clip 106(4) to the opposite side of the locking clip 106(4).

A straight groove 1124 is defined in the elongate projection 1108. The straight groove 1124 is configured to slidingly engage with one or more retaining projections of a clip 106. For example, a user 800 can slidingly engage the straight groove 1124 with the retaining projections 314(1) and 314(3) of the inner clip 106(1). The example of FIG. 10C depicts the straight groove 1124 as having a Y-shaped cross section. This allows the straight groove 1124 to slidingly engage with a Y-shaped retaining projection(s) 314 of the inner clip 106(1), for example. It is to be appreciated, however, that the straight groove 1124 can have a cross section of a different shape, such as a dovetail-shaped (or substantially triangular-shaped) cross section, a T-shaped cross section, or the like. These cross-sectional shapes prevent the locking clip 106(4) from sliding off of the retaining projection(s) 314 of the inner clip 106(1) in the Z-direction. In other words, a user can remove the locking clip 106(4) from an inner clip 106(1) by sliding the locking clip 106(4) all the way off of the retaining projection(s) 314 of the inner clip 106(1) in the Y-direction (or the X-direction, as the case may be), but a user is inhibited from removing the locking clip 106(4) from the inner clip 106(1) by simply pulling the locking clip 106(4) away from the inner clip 106(1) in the Z-direction. This is due to the cross-sectional shape of the straight groove 1124 defined in the elongate projection 1108 of the locking clip 106(4).

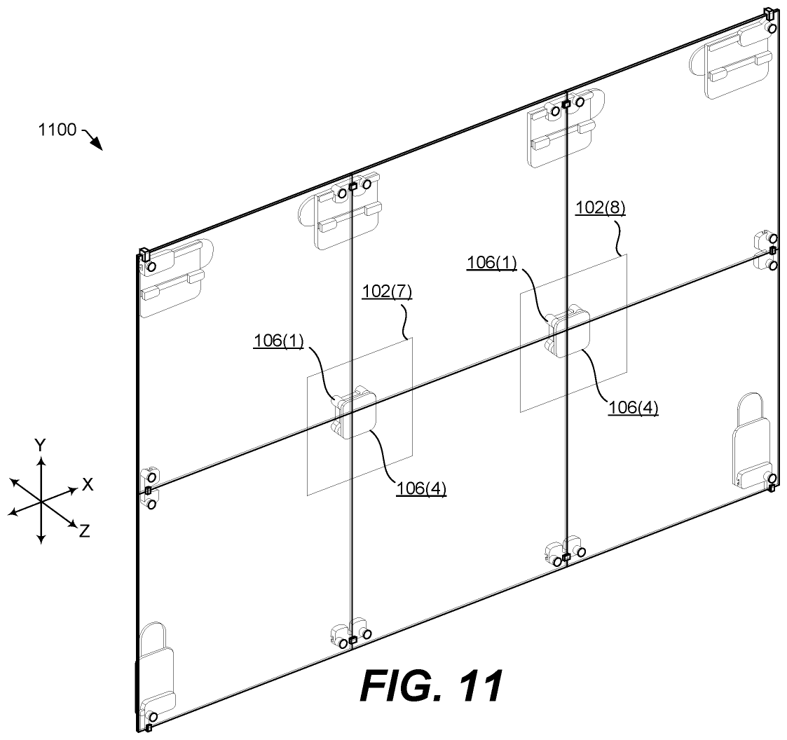

FIG. 11 illustrates an example decoration 1100 that can be created using the locking clip 106(4) of FIGS. 10A-10D. The decoration 1100 is similar to the decoration 200 shown in FIG. 2, except that the locking clips 106(4) allow for attaching additional pieces of material 102 to the decoration 1100, such as the piece of material 102(7) and the piece of material 102(8), which may themselves be coupled to (e.g., using adhesive, magnets, etc.) to the planar front surfaces 1106 of the locking clips 106(4). In some examples, an individual locking clip 106(4) may include, or may be configured to receive, a magnet or a piece of metal (e.g., in the middle of the planar front surface 1106). In this manner, the additional pieces of material 102(7) and 102(8) can be easily coupled to, and removed from, the locking clips 106(4)_using a corresponding magnet or piece of metal in the additional pieces of material 102(7) and 102(8), which allows a user 800 to swap the pieces of material 102(7) and 102(8) for others with minimal effort. In some examples, the additional pieces of material 102(7) and 102(8) may be or include letters and/or numbers to spell words, and a magnetic element of the locking clip 106(4) may allow such additional pieces of material 102(7) and 102(8) to be easily switched, rearranged, etc. These additional pieces of material 102(7) and 102(8) may occlude the inner clips 106(1) when the decoration 1100 is viewed from the front. As such, the locking clips 106(4) may allow for providing a different aesthetic to a decoration 1100. Additionally, or alternatively, the locking clips 106(4) may prevent the pieces of material 102(1) to 102(6) from coming off of the other clips 106, such as the inner clips 106(1). It should also be appreciated that the pieces of material 102 in FIG. 11 are depicted as translucent pieces of material so that the clips 106, the hanging elements 108, and the command strips 110 that would otherwise be occluded by the pieces of material 102 can be seen.

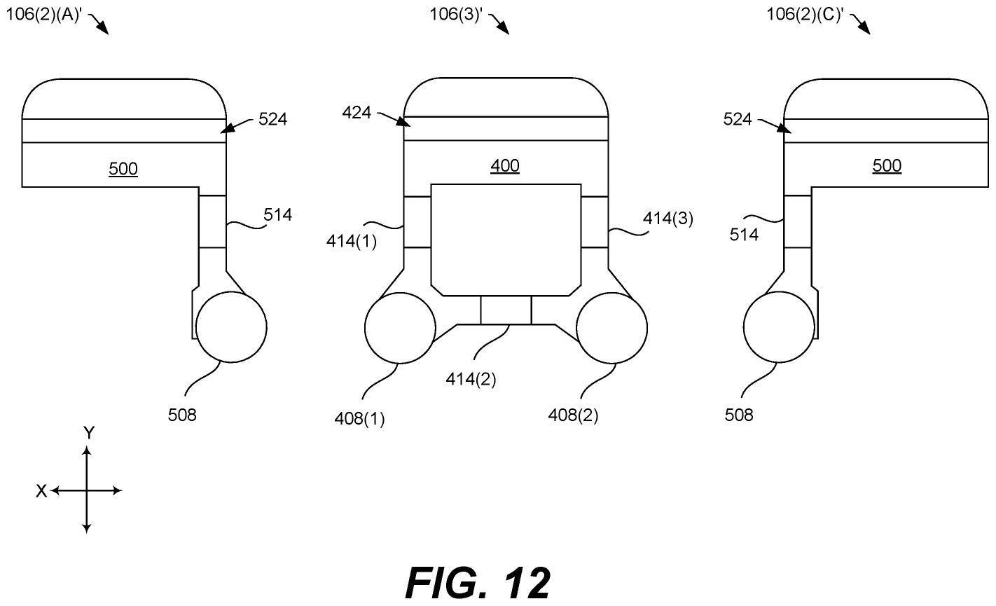

FIG. 12 illustrates other example corner and edge clips 106 that may be included in a kit for interconnecting and hanging pieces of material 102, such as the kit 100 of FIG. 1, or a similar kit. For example, FIG. 12 illustrates an upper-left corner clips 106(2)(A)′, an upper edge clip 106(3)′, and an upper-right corner clip 106(2)(C)′. These clips 106 have similar features to the other clips 106 described herein. For example, each of the corner clips 106(2)(A)′ and 106(2)(C)′ have a post 508 and a retaining projection 514, as described in detail elsewhere herein. The upper edge clip 106(3)′ has two posts 408(1) and 408(2), and three retaining projections 414(1), 414(2), and 414(3). These features will not be described in more detail herein, as they have already been described above with reference to the other clip 106 designs.

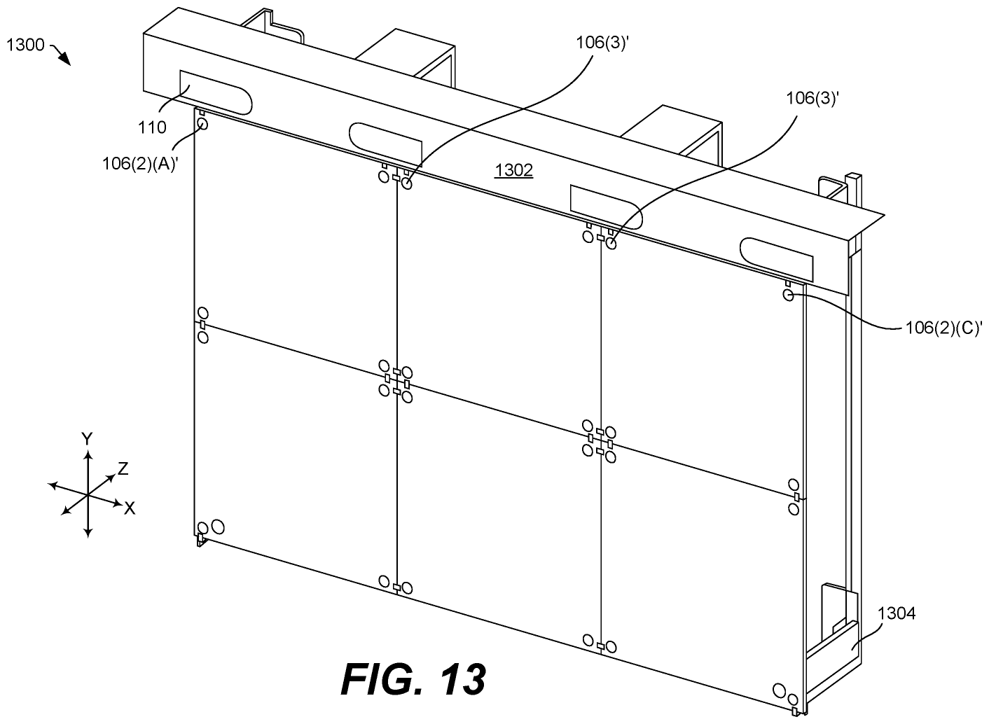

In contrast to the previously-described clip designs, the clips 106(2)(A)′, 106(3)′, and 106(2)(C)′ of FIG. 12 each have a straight groove 424, 524 defined in a planar front surface of the base 400, 500 of the clip 106 (as opposed to a straight groove defined in the planar back surface thereof). This allows for creating a “floating” decoration 1300 by virtue of hanging the pieces of material 102 on a different type of structure, such as a rail 1302, which is illustrated in FIG. 13. That is, the straight grooves 424, 525 that are defined in the planar front surfaces of the bases 400, 500 of the clips 106(2)(A)′, 106(3)′, and 106(2)(C)′ shown in FIG. 12 are configured to slidingly engage with respective straight rails 608 of the top hanging element 108(1), and the top hanging elements 108(1) can be mounted to a structure, such as a rail 1302, as shown in FIG. 13. For example, the rail 1302 shown in FIG. 13 can be mounted to a wall or to a ceiling to crate a floating wall decoration 1300. It is to be appreciated that the clips 106(2)(A)′, 106(3)′, and 106(2)(C)′ shown in FIG. 12 can also be used at the bottom of the decoration 1300 in an inverted orientation to have the bottom row of pieces of material 102 connected to another rail 1302 that is also inverted with respect to the orientation of the rail 1302 shown in FIG. 13. In other words, instead of a single rail 1302, the decoration 1300 could have two rails 1302, one on the top and one on the bottom, in some examples.

In some examples, lighting can be disposed behind the pieces of material 102 in the decoration 1300 of FIG. 13 to illuminate the pieces of material 102 and/or the lines between the pieces of material 102 to create various art decorations. In some examples, a bottom hanging element 1304 can be used with the rail 1302 structure implementation in order to maintain a spaced distance between a wall and the pieces of material 102 and/or to hold a light emitting element(s), such as a light emitting diode (LED) strip and/or to hold a light shade to cover up space on the decoration 1300 so that a person cannot see behind the decoration 1300 from the side. It should also be appreciated that the command strips 110 in FIG. 13 would be occluded by the rail 1302, unless the rail 1302 is translucent. The command strips 110 are shown merely to illustrate that the top hanging elements 108 are mounted to the rail 1302 being the front surface thereof.

Unless otherwise indicated, all numbers expressing quantities used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value. Notwithstanding that the numerical ranges and parameters are approximations, the numerical values set forth in the specific examples are reported as precisely as possible.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein does not pose a limitation on the scope of the claims. No language in the specification should be construed as indicating any non-claimed element essential to the practice of the claimed apparatus or process.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

What is claimed is:

1. A clip comprising:
a base comprising:
a planar front surface;
a post extending from the planar front surface at a first location on the planar front surface, wherein the post is configured to be inserted through a hole defined in a piece of material; and
a retaining projection extending from the planar front surface at a second location on the planar front surface, the second location being spaced a distance from the first location, wherein a distal end of the retaining projection is wider than a proximal end of the retaining projection to create one or more notches between the retaining projection and the planar front surface, and wherein the retaining projection is configured to inhibit the piece of material from sliding off of the post by virtue of a portion of the piece of material being disposed in a notch of the one or more notches when the post is disposed through the hole.

2. The clip of claim 1, wherein the post is taller than the retaining projection, as measured from the planar front surface to respective distal ends of the post and the retaining projection.

3. The clip of claim 1, wherein the post is widest at a proximal end of the post.

4. The clip of claim 1, wherein:
the post is a first post;
the piece of material is a first piece of material;
the notch is a first notch at a first side of the retaining projection;
the base further comprises a second post extending from the planar front surface at a third location on the planar front surface, the third location being spaced the distance from the second location;
the second post is configured to be inserted through a hole defined in a second piece of material;
the retaining projection is disposed between the first post and the second post;
the one or more notches further comprise a second notch at a second side of the retaining projection opposite the first side; and
the retaining projection is configured to inhibit the second piece of material from sliding off of the second post by virtue of a portion of the second piece of material being disposed in the second notch when the second post is disposed through the hole defined in the second piece of material.

5. The clip of claim 4, wherein:
the retaining projection is a first retaining projection;
the base comprises four cross members adjoined at four corners of the base to form an opening in a middle of the base bounded by the four cross members;
the base comprises four posts including the first post, the second post, a third post, and a fourth post, the four posts located at the four corners of the base; and
the base comprises two retaining projections including the first retaining projection and a second retaining projection, the first retaining projection located at a center of a first cross member of the four cross members, and the second retaining projections located at a centers of a second cross member of the four cross members, the first cross member and the second cross member being on opposite sides of the base.

6. The clip of claim 5, wherein each post of the four posts is taller than each retaining projection of the two retaining projections, as measured from the planar front surface to respective distal ends of the four posts and the two retaining projections.

7. The clip of claim 4, wherein:
the retaining projection is a first retaining projection;
the base comprises four cross members adjoined at four corners of the base to form an opening in a middle of the base bounded by the four cross members;
the base comprises four posts including the first post, the second post, a third post, and a fourth post, the four posts located at the four corners of the base; and
the base comprises four retaining projections including the first retaining projection, a second retaining projection, a third retaining projection, and a fourth retaining projection, the four retaining projections located at respective centers of the four cross members.

8. The clip of claim 1, wherein the base further comprises:
a planar back surface; and
a straight groove defined in at least one of the planar front surface or the planar back surface and configured to slidingly engage with a straight rail of a hanging element.

9. A hanging element comprising:
a base comprising:
a planar front surface;
a straight rail extending from the planar front surface at a periphery of the base and extending along a side of the base, wherein the straight rail is configured to slidingly engage with a straight groove defined in a clip; and
a planar back surface configured to be mounted to a structure with an adhesive.

10. The hanging element of claim 9, wherein the straight rail has a T-shaped cross section.

11. The hanging element of claim 9, wherein:
the structure is a wall; and
the base further comprises one or more hooks configured to be hooked onto a top edge of a ruler for mounting the hanging element to the wall.

12. The hanging element of claim 11, wherein the one or more hooks comprise a pair of hooks that are equidistant from a center line of the base that is orthogonal to the straight rail.

13. The hanging element of claim 11, wherein the one or more hooks comprise a pair of hooks that are equidistant from the straight rail.

14. The hanging element of claim 11, wherein the one or more hooks comprise a pair of hooks that are spaced apart with a gap between the pair of hooks.

15. The hanging element of claim 11, wherein the one or more hooks curve away or angle away from the straight rail.

16. A kit for interconnecting and hanging pieces of material, the kit comprising:
multiple pieces of material, each piece of material having at least one hole, or perforations to make the at least one hole, at a periphery of the piece of material;
multiple clips, each clip being configured to be coupled to one or more of the multiple pieces of material; and
multiple hanging elements, individual ones of the hanging elements being configured to slidingly engage with a clip of the multiple clips and to be mounted to a structure with an adhesive.

17. The kit of claim 16, wherein an individual clip of the multiple clips comprises:
a base comprising:
a planar front surface;
a post extending from the planar front surface at a first location on the planar front surface, wherein the post is configured to be inserted through the at least one hole; and
a retaining projection extending from the planar front surface at a second location on the planar front surface, the second location being spaced a distance from the first location, wherein a distal end of the retaining projection is wider than a proximal end of the retaining projection to create one or more notches between the retaining projection and the planar front surface, and wherein the retaining projection is configured to inhibit the piece of material from sliding off of the post by virtue of a portion of the piece of material being disposed in a notch of the one or more notches when the post is disposed through the at least one hole.

18. The kit of claim 16, wherein the multiple clips comprise:
one or more inner clips having at least four posts and at least two retaining projections;
one or more edge clips having at least two posts and at least one retaining projection; and
one or more corner clips having at least one post and at least one retaining projection.

19. The kit of claim 16, wherein an individual hanging element of the multiple hanging elements comprises:
a base comprising:
a planar front surface;
a straight rail extending from the planar front surface at a periphery of the base and extending along a side of the base, wherein the individual hanging element is configured to slidingly engage with the clip by slidingly engaging the straight rail with a straight groove defined in the clip; and
a planar back surface, wherein the individual hanging element is configured to be mounted to the structure with the adhesive by mounting the planar back surface to the structure with the adhesive.

20. The kit of claim 16, wherein the multiple hanging elements comprise:
one or more top hanging elements having a first straight rail configured to slidingly engage with a straight groove defined in the clip; and
one or more bottom hanging elements having at least one of:
a second straight rail configured to slidingly engage with a straight groove defined in another clip of the multiple clips; or
at least one post and at least one retaining projection.
